(19) United States
(12) Patent Application Publication
(10) Pub. No.: US 2026/0319581 A1
(43) Pub. Date: Oct. 15, 2026

(54) SELECTING CONTEXT FOR CUSTOMIZED ACTIONS

(71) Applicant: GOOGLE LLC, Mountain View, CA (US)

(72) Inventors: Mar Gonzalez Franco, Seattle, WA (US); Lucy Abramyan, Los Gatos, CA (US); Eric Jordan Gonzalez, Seattle, WA (US); Xiaoan Liu, Brooklyn, NY (US); Connie Wenya Huang, Laguna Hills, CA (US); Andrea Colaco, Los Altos, CA (US)

(21) Appl. No.: 19/642,963

(22) Filed: Apr. 9, 2026

Related U.S. Application Data
(60) Provisional application No. 63/786,201, filed on Apr. 9, 2025.

(51) Int. Cl. G06F 3/01; G06F 3/16; G06F 40/00; G06T 7/73; G06T 15/06; G06T 19/00; G06V 20/20; G06V 30/30

(52) U.S. Cl. CPC G06F 3/013; G06F 3/017; G06F 3/167; G06F 40/00; G06T 7/75; G06T 15/06; G06T 19/006; G06T 2207/10028; G06T 2207/30204; G06T 2207/30244; G06T 2210/12; G06T 2210/21; G06T 2210/56; G06V 20/20; G06V 30/30

(57) ABSTRACT

A method including identifying a first object in a physical environment at a first scale of interaction corresponding to a component of the first object, identifying a second object in the physical environment at a second scale of interaction corresponding to a functional relationship between the second object and at least one of the first object or a third object, generating, using a first model, a prompt based on the first object, the second object, and the third object, retrieving, using a second model, information based on the prompt, and displaying a visual overlay based on the information. In some implementations, the first model and the second model can be a multi-modal model that includes the first model and the second model.

### CROSS REFERENCE TO RELATED APPLICATION

This application claims priority to U.S. Provisional Application No. 63/786,201, filed on Apr. 9, 2025, the disclosure of which is incorporated by reference herein in its entirety.

### BACKGROUND

Multimodal large language models have enabled augmented reality (AR) systems to move beyond simple object identification toward deeper environmental reasoning. By integrating real-time visual tracking with intelligent middleware, these systems can interpret complex physical contexts and user gestures to provide relevant assistance to users of AR systems.

### SUMMARY

Semantic Reality is an AR system that uses artificial intelligence to help users interact more deeply with the objects around them. Instead of just identifying a single item, some implementations can evaluate the environment across three distinct scales of interaction: a detail-level, an object-level, and an environment-level. For example, a student working on a biology project could point their AR glasses at a specific leaf on a plant to see a magnified view of its cell structure (detail-level), receive a summary of the plant’s care instructions (object-level), or see a visual map connecting the plant to the specific fertilizers and sunlight levels needed for it to thrive (environment-level). Similarly, a student trying to set up a new smart home device could use the system to identify what every small port on the back of the device does or see a step-by-step visual guide linking the device to their router and phone to complete the installation. By bridging the gap between physical items and digital information, the system allows users to learn and complete tasks through natural actions like pointing or picking up objects.

Users of AR, mixed reality (XR), and/or virtual reality (VR) sometimes select context in a field of view that can become the basis for other actions or tasks. In some implementations, the field of view can be a viewport of an AR or XR headset or a smartphone front-facing camera. In some implementations, the context can be selected to be the basis of a query. In some implementations, the context can be selected to be used as input for an artificial intelligence (AI) model, such as a large language model. The model can include, for example, a large vision model, a large language model, a multimodal model, or any other model operable to identify environmental context and/or user context relevant to the guidance instruction. In some implementations, the context can be used to generate one or more prompts for an AI model that can be relevant to the user. In some implementations, the context can be used with a prompt (a suggested one or a user-created one) to generate an answer that is relevant to the environment around the user.

In a general aspect, a device, a system, a non-transitory computer-readable medium (having stored thereon computer-executable program code which can be executed on a computer system), and/or a method can perform a process with a method including a method including identifying a first object in a physical environment at a first scale of interaction corresponding to a component of the first object, identifying a second object in the physical environment at a second scale of interaction corresponding to a functional relationship between the second object and at least one of the first object or a third object, generating, using a first model, a prompt based on the first object, the second object, and the third object, retrieving, using a second model, information based on the prompt, and displaying a visual overlay based on the information. In some implementations, the first model and the second model can be a multi-modal model that includes the first model and the second model.

### BRIEF DESCRIPTION OF THE DRAWINGS

Example implementations will become more fully understood from the detailed description given herein below and the accompanying drawings, wherein like elements are represented by like reference numerals, which are given by way of illustration only and thus are not limiting of the example implementations.

FIG. 1 illustrates a pictorial use of a semantic reality system according to at least one example implementation.

FIG. 2 illustrates a block diagram of a signal flow for a semantic reality system architecture according to at least one example implementation.

FIG. 3 illustrates a block diagram of the machine learning (ML) module of the semantic reality system architecture of FIG. 2 according to at least one example implementation.

FIG. 4 illustrates a block diagram of a method for transforming raw environmental data into context-aware digital assistance through a multi-stage processing pipeline according to at least one example implementation.

FIG. 5 illustrates a block diagram showing the semantic reality system categorizes identified functional relationships into a taxonomy of semantic structures according to at least one example implementation.

FIG. 6 illustrates a block diagram of a continuous feedback loop to maintain environmental awareness and ensure the spatial accuracy of digital overlays in the semantic reality system according to at least one example implementation.

FIG. 7 illustrates a block diagram of a specialized interaction pipeline for the selection and processing of localized sub-regions on a physical object according to at least one example implementation.

FIG. 8 illustrates a block diagram of a method for operating the semantic reality system according to at least one example implementation.

It should be noted that these figures are intended to illustrate the general characteristics of methods, and/or structures utilized in certain example implementations and to supplement the written description provided below. These drawings are not, however, to scale and may not precisely reflect the precise structural or performance characteristics of any given implementation and should not be interpreted as defining or limiting the range of values or properties encompassed by example implementations. For example, the positioning of modules and/or structural elements may be reduced or exaggerated for clarity. The use of similar or identical reference numbers in the various drawings is intended to indicate the presence of a similar or identical element or feature.

### DETAILED DESCRIPTION

Semantic Reality is an augmented reality (AR) system that leverages multimodal large language models (MLLMs) to transform how users perceive and interact with their physical environment. Moving beyond traditional AR, which often treats the real world as a static background for digital overlays, this technology treats physical objects as active, intelligent entities. By integrating real-time computer vision with advanced environmental reasoning, the system bridges the gap between raw visual data and actionable digital intelligence, allowing users to engage with their surroundings through natural, embodied actions such as pointing, grabbing, or arranging objects.

Some implementations include a hierarchical interaction architecture that operates across three distinct scales of interaction (e.g., levels of granularity): the detail-level, the object-level, and the environment-level. At the detail-level, users can inspect localized sub-components of an object, such as specific ports on an electronic device or fine print on a label. The object-level identifies and anchors individual items as persistent digital entities, while the environment-level (e.g., the semantic layer) interprets the functional relationships and dependencies between multiple objects. This multi-tiered approach allows the system to understand not just what an object is, but how it works and how it relates to other items in a broader workflow or task.

Semantic Reality can be configured to utilize an intelligent middleware layer that functions as a multi-agent AI system. One AI agent optimizes and expands user interactions (e.g., as a simple gesture or a brief voice query) into sophisticated prompts for a second, specialized model. This process reduces the prompting burden on the user, enabling the system to predict needs and provide nonverbal feedback through visual highlights and relationship lines. By maintaining a continuous scene graph and compensating for spatial drift, some implementations can ensure that digital information remains registered to the physical world, fostering a seamless human-to-AI symbiosis in complex or unfamiliar environments.

The Semantic Reality system can be configured to provide actionable intelligence across various real-world scenarios, leveraging its multi-level interaction architecture to assist users in complex or unfamiliar environments. By integrating detail-level, object-level, and environment-level reasoning, the system can provide assistance to a user setting up a complex smart home gateway. For example, the user can use the system to demystify the physical interface of the device. At the detail-level, the user points to specific ports on the back of the gateway, triggering the system to overlay digital labels explaining each port's function (e.g., WAN vs. LAN) and compatibility. At the environment-level, the system identifies the user’s router and smartphone in the room, generating a sequential visual guide with relationship lines that show how to cable the devices together and which app to open to complete the digital handshake.

By integrating detail-level, object-level, and environment-level reasoning, the system can provide assistance in a laboratory setting. For example, the system can function as a proactive safety agent by interpreting the functional dependencies and risks between hazardous items. For example, if a user places a portable hard drive on a workbench next to a cup of liquid, the environment-level interaction layer identifies the predictive hazard relationship between the two objects. The system then surfaces a nonverbal visual highlight and a preventative instruction, such as "Move the liquid to avoid damage to the storage device," effectively establishing a theory of mind that predicts and prevents physical accidents.

By integrating detail-level, object-level, and environment-level reasoning, the system can provide assistance to a student studying botany. For example, the student can engage in situated learning by interacting with a plant at multiple granularities to understand its biological and environmental needs. By focusing on a single leaf (detail-level), the student can view a magnified AR overlay of cellular structures or nutrient deficiencies. When the student steps back to view the whole plant (object-level), the system provides a summary of care instructions; simultaneously, at the environment-level, it maps the plant’s relationship to nearby light sources and humidity sensors, providing a holistic view of the ecosystem for the plant to thrive.

Traditional AR systems have primarily focused on the identification and tracking of individual, isolated objects. In these systems, the real world is often treated as a static background for digital overlays, where interaction is limited to a single scale of interaction (e.g., typically identifying what an object is and providing a fixed set of information or a virtual menu associated with that specific item). These systems often rely on manual pre-registration of objects or closed-set computer vision models that can only recognize a predefined list of categories.

At least one technical problem with these systems is their lack of environmental reasoning and situational awareness. Because they treat objects as unconnected entities, they cannot interpret the functional dependencies, relational meaning, or broader workflows that exist between multiple objects in a scene. Furthermore, these systems often impose a high prompting burden on the user, requiring explicit text or voice queries to retrieve specific information. This results in a fragmented user experience where the AI fails to foresee user needs or provide proactive assistance based on the physical context. Additionally, traditional AR interfaces frequently struggle with perceptual transparency, making it difficult for users to understand what the AI actually perceives or how it intends to assist them in complex, multi-object tasks like equipment assembly or industrial safety monitoring.

At least one technical solution to the technical problems associated with traditional AR is that the Semantic Reality system implements a hierarchical interaction architecture that operates across three distinct scales of interaction: detail-level, object-level, and environment-level. To achieve this, the system utilizes high-precision raycasting to transform 2D interactions on an image plane into grounded 3D coordinates. Specifically, the anchor module 215 utilizes stored camera poses and 2D bounding boxes to cast rays that intersect with a spatial mesh of the physical environment, establishing persistent digital anchors and sub-anchors. At the detail-level, this allows for the creation of sub-anchors within an object's local coordinate space, enabling users to interact with localized sub-components like specific ports or labels. At the object-level, physical items are represented as digital anchors to provide stable reference points for information retrieval.

At least one technical advantage of the technical solution can be that the Semantic Reality system replaces static, isolated object tagging with dynamic, hierarchical interaction architecture. Traditional systems suffer from a high prompting burden, requiring users to manually input text or voice queries to retrieve information, and they lack the environmental reasoning necessary to understand how multiple objects relate to one another.

The technical solution implemented in Semantic Reality resolves these issues by using an intelligent middleware layer that functions as a multi-agent AI system. This architecture automatically expands natural physical interactions (e.g., such as pointing, grabbing, or arranging objects) into sophisticated prompts for a secondary model, effectively triggering context-aware queries without explicit user input. Furthermore, by generating a real-time scene graph at the environment-level, the system can interpret functional dependencies and predictive hazards, such as identifying the risk of a liquid spilling onto an electronic device. This multi-tiered approach ensures perceptual transparency, allowing the AI to predict user needs and provide proactive, nonverbal feedback through visual highlights and relationship lines, which significantly lowers the entry point for learning and task completion in complex environments.

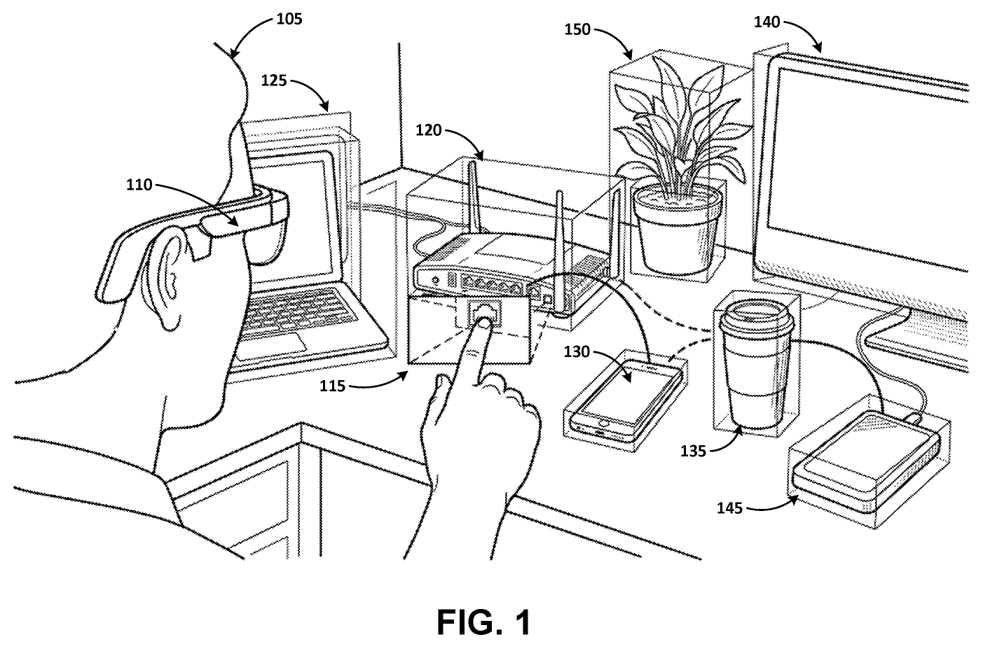

FIG. 1 illustrates a pictorial use of a semantic reality system according to at least one example implementation. As shown in FIG. 1, the Semantic Reality system is illustrated within a multifaceted physical workspace, demonstrating the integration of an AR environment with real-time digital intelligence. A user 105 is shown wearing a wearable device 110 (e.g., a head-mounted display (HMD), smart glasses, and the like), which serves as the interface for visualizing hierarchical digital overlays. The illustration captures a first-person perspective of the user interacting with a variety of physical objects, including a network router 120, a smartphone 130, a laptop 125, and a desktop monitor 140 with an attached peripheral hard drive 145. These objects are represented as active digital entities within the system’s spatial coordinate space, enabling the wearable device 110 to surface contextually relevant information and functional dependencies.

The architecture of the system is depicted through three distinct scales of interaction (e.g., levels of granularity). At the detail-level, a localized interaction (e.g., pointing gesture 115) is shown where the user’s hand performs a pointing gesture toward a specific Ethernet port on the back of router 120. This interaction can trigger a high-precision sub-anchor, represented by a dashed rectangular callout, which allows the user to engage with sub-components of an object that would otherwise be inaccessible through broader identification. This layer can be associated with tasks requiring precise technical configuration or the interpretation of fine-print labels, effectively bridging the gap between a physical interface and digital assistance.

At the object-level, individual items such as the smartphone 130, the beverage container 135, and the potted plant 150 are enclosed in thin-lined 3D bounding boxes. These boxes represent persistent digital anchors that maintain spatial registration with the physical objects even as the user moves throughout the environment. This layer identifies the specific identity of each object and provides a stable reference point for retrieving targeted information, such as care instructions for the plant 150 or the status of the peripheral hard drive 145. By anchoring these digital entities to the real world, the system can establish a foundation for situated learning and interaction.

The environment-level, or semantic layer, is illustrated through the use of relationship lines and connectivity graphs that interpret the functional and relational meaning between multiple objects. For example, a dashed relationship line is shown connecting the smartphone 130 to router 120, indicating a data or power dependency recognized by the system’s intelligent middleware. Another curved path connects the beverage container 135 to the peripheral hard drive 145, illustrating the system’s ability to reason about theory of mind and predictive hazards, such as the risk of a liquid spill damaging electronic equipment. This layer enables the user to understand not just what an object is, but how it fits into a broader workflow or physical context.

Collectively, FIG. 1 demonstrates how the Semantic Reality system reduces the prompting burden on the user by triggering sophisticated AI queries through natural physical actions rather than explicit text input. The nonverbal feedback provided by the visual overlays and relationship lines ensures perceptual transparency, allowing the user to see what the AI perceives and how it anticipates their needs. By integrating these three scales of interaction (e.g., levels of granularity, detail, object, and environment) the system can foster a seamless human-to-AI symbiosis, lowering the entry point for learning and task completion in complex, multi-object environments.

The Semantic Reality system is illustrated as a method for interacting with a physical environment through a hierarchical digital architecture. The system includes a first-person view from a user 105 wearing a wearable device 110, which identifies objects at varying scales of interaction. At a first scale of interaction corresponding to a sub-component of a first object, the user is shown performing a pointing gesture 115 toward a specific Ethernet port on a network router 120. This detail-level interaction allows the system to surface precise technical data or sub-anchored overlays. Simultaneously, the system identifies a second object, such as a laptop 125, smartphone 130, or a beverage container 135, at a second scale of interaction corresponding to an object-level digital representation.

Further, the system identifies a third object, such as a peripheral hard drive 145 or a monitor 140, at a third scale of interaction corresponding to a functional relationship between the objects. This environment-level interaction can be visualized through relationship lines that connect the router 120 to the smartphone 130 or the beverage container 135 to the hard drive 145, representing a scene graph of functional dependencies or predictive hazards. Using a first model, the system generates a prompt based on these identified objects and their spatial context (e.g., triggered by natural physical actions rather than text input) and retrieves information via a second model. In some implementations, the first model and the second model can be a multi-modal model that includes the first model and the second model. The resulting information is then displayed as a visual overlay, such as a dashed bounding box or a connectivity graph, which remains registered to the physical environment even as objects move or the user’s perspective changes.

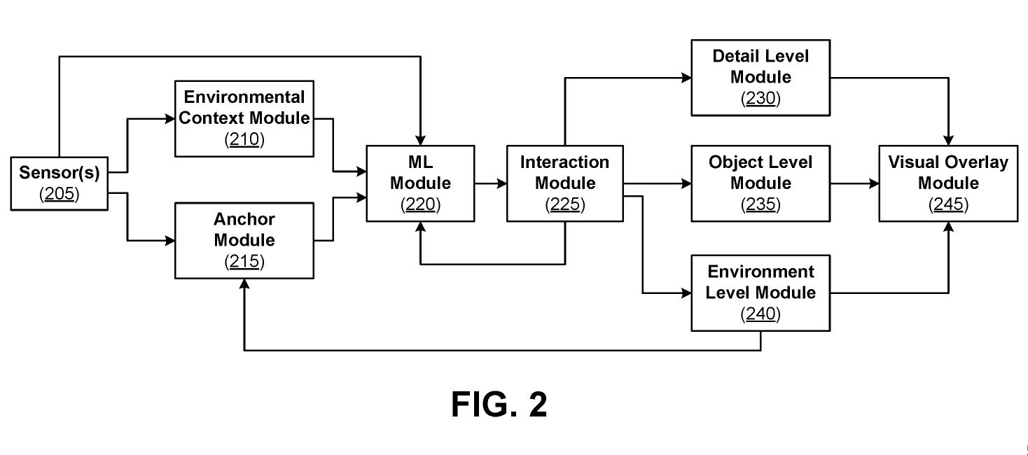

FIG. 2 illustrates a block diagram of a signal flow for a semantic reality system architecture according to at least one example implementation. As shown in FIG. 2, the Semantic Reality system is organized into a modular architecture that transforms raw environmental data into a contextually aware digital overlay. The system can be configured to process multiple streams of information through centralized processing, which coordinates the identification of physical objects and their surrounding environmental context. This central logic layer interfaces with an interaction framework that categorizes data into a multi-tiered scale of interaction (e.g., levels of granularity). By analyzing the physical environment at varying scales, the system can distinguish between individual object properties, localized sub-components, and the broader relational dependencies that define a workspace. This hierarchical analysis can be synthesized to generate visual feedback, ensuring that digital information remains anchored to the real world while providing the user with task-relevant intelligence.

As shown in FIG. 2, the system architecture includes sensor(s) 205 configured to capture and provide environmental data to an environmental context module 210, an anchor module 215, and a machine learning (ML) module 220, which functions as an intelligent middleware to process these inputs and direct an interaction module 225 to categorize the data across a detail level module 230, an object level module 235, and an environment level module 240 that generate data or information that can be synthesized into a coherent digital representation via a visual overlay module 245.

Sensor(s) 205 can be configured to capture and provide raw environmental data to the semantic reality system. The sensor(s) 205 can include one or more sensing components integrated into or communicatively coupled with a wearable device (e.g., wearable device 110) to capture the physical state of a user (e.g., user 105) and the surrounding environment. For example, the sensor(s) 205 can include a pass-through RGB camera and depth sensors, such as LiDAR or time-of-flight sensors, configured to capture real-time visual snapshots and spatial geometry of the workspace. These sensors can allow the system to collect image data, such as the appearance of a network router 120 or the fine-print text on a supplement label, while simultaneously generating a spatial mesh that defines the 3D coordinates of the room. Further, the sensor(s) 205 can include inward-facing and outward-facing infrared sensors for tracking gaze fixation and hand positions, enabling the system to detect natural physical interactions like pointing, grabbing, or reaching toward an object.

The data collected by the sensor(s) 205 can function as the input for environmental reasoning. Visual snapshots can be captured at a regular sample rate (e.g., every 10 seconds) to provide a continuous stream of frames for activity recognition and object identification. This data can include two-dimensional (2D) bounding boxes and candidate semantic labels for items within the field of view. Sensor(s) 205 can be configured to provide high-precision tracking data, including the camera pose (e.g., representing the position and orientation of wearable device 110) and the three-dimensional (3D) coordinates of, for example, the user’s fingertips. By capturing the proximity of a user’s hand to a physical surface, the sensor(s) 205 can be configured to provide the spatial context to identify when a user is engaging with a specific sub-component of an object (e.g., a localized port or a dial).

In some implementations, sensor(s) 205 can include environmental sensors and user-tracking components configured to facilitate the multi-level interaction architecture. For example, the sensor(s) 205 can include one or more outward-facing cameras, such as RGB or infrared sensors, and depth-sensing hardware (e.g., LiDAR or time-of-flight sensors) integrated into, for example, the wearable device 110. Sensor(s) 205 can be configured to capture raw visual and spatial data from the physical environment, enabling the system to establish 3D digital anchors and sub-anchors within a spatial mesh. Additionally, the sensor(s) 205 can include inward-facing sensors for gaze tracking and outward-facing sensors for high-precision hand and finger tracking.

By monitoring parameters such as fingertip proximity to surfaces and gesture stability, the sensor(s) 205 can provide the inputs used to distinguish between a detail-level interaction directed at a sub-component and an object-level interaction directed at a whole entity. In some implementations, the sensor(s) 205 can also include microphones for capturing voice queries, which are processed alongside spatial data to reduce the prompting burden on the user. In some implementations, sensor(s) 205 can capture data used to generate skeletal hand data to recognize gestures and fingertip proximity to surfaces, providing the spatial and temporal precision desired to trigger detail-level interactions with sub-components or to identify predictive hazards, such as the proximity of a liquid container to electronic equipment.

As shown in FIG. 2, the interaction module 225 can function as a categorization and distribution process that organizes environmental and user data into a structured hierarchy of interaction scales. Interaction module 225 can be configured to receive processed multimodal inputs from ML module 220 and parse them into the appropriate semantic tier: detail-level, object-level, or environment-level. To facilitate this, the interaction module 225 can be configured to detect a user intent cue comprising at least one of a fingertip proximity threshold, a gesture stability duration, or a gaze fixation metric. The interaction module 225 then filters the user intent cue through a semantic hierarchy to automatically select the target scale of interaction. For example, a fingertip proximity cue combined with gaze fixation may be filtered to trigger a detail-level interaction, whereas a broad grasping gesture may be filtered to select an object-level interaction. This hierarchical filtering can ensure that the system provides contextually relevant digital assistance calibrated to the user's specific level of focus, effectively bridging the gap between raw sensor data and actionable environmental reasoning.

Environmental context module 210 can be configured to receive and synthesize data from the sensor(s) 205 to provide a high-level understanding of the physical environment. For example, the environmental context module 210 can be configured to process visual snapshots captured by an RGB camera at a regular sample rate (e.g., every 10 seconds) to perform scene classification and activity recognition. By analyzing the labels and spatial distribution of identified objects (e.g., a laptop, desk, and power outlets) the environmental context module 210 can infer a plausible scene type (e.g., an office or laboratory) and determine a list of likely tasks or workflows relevant to that specific context.

The data collected and analyzed by the environmental context module 210 can be used to determine situational awareness within the system. This data can include structured environment metadata, such as an identified scene category, a set of active object anchors, and detected human actions or gestures captured via infrared hand-tracking sensors. For example, if the sensor(s) 205 captures an image of a beverage container 135 placed in proximity to a peripheral hard drive 145, the environmental context module 210 can identify the spatial relationship and potential functional dependencies between these objects. This enables the system to maintain a continuously updated model of the user’s surroundings, which can be used to prioritize information retrieval and anticipate user needs based on the real-world physical context.

The environmental context module 210 can be configured to analyze the physical environment by synthesizing raw sensor data into a structured semantic representation, often referred to as a scene graph. To identify spatial relationships and functional dependencies between objects, environmental context module 210 can utilize multimodal large language models (MLLMs) to perform visual reasoning across multiple frames. By evaluating the spatial proximity and relative positioning of identified object anchors (e.g., beverage container 135 placed near a peripheral hard drive 145) the environmental context module 210 can infer relational meanings that transcend simple object identification. This analysis allows the system to categorize relationships into specific tiers, such as grouping related items, identifying parallel or interchangeable options, and establishing sequential task flows for assembly or configuration.

In some implementations, environmental context module 210 can use advanced models (e.g., machine learning) to establish a theory of mind regarding the physical state of the workspace. For example, the environmental context module 210 can utilize Segment Anything Model (SAM) for object boundary identification or multimodal large language models (MLLMs) for semantic reasoning. For example, the environmental context module 210 can utilize a computer vision pipeline involving 2D-to-3D re-projection and raycasting against a spatial mesh to determine the 3D coordinates of objects. Once these entities are localized, a visual reasoning agent can identify predictive hazard relationships, such as the risk of a liquid spill damaging nearby electronics. This environmental reasoning can enable environmental context module 210 to foresee or predict user needs and trigger proactive assistance (e.g., generating relationship lines or preventative instructions) without requiring explicit natural language queries from the user.

In some implementations, the environmental context module 210 can utilize a predictive state-space model to establish a technical theory of mind regarding the physical environment. This process involves the ML module 220 simulating a plurality of physical trajectories or state changes based on the current 3D spatial mesh and identified object metadata. For example, if the system identifies a first object as a “liquid container” and a second object as “sensitive electronics,” the environment level module 240 calculates a probability of a negative physical consequence (e.g., a spill or thermal interference) by modeling the volumetric interaction between the objects' bounding boxes in a simulated physics engine. By comparing the current environmental state against a library of safe versus hazardous state templates, the first model can preemptively identify a predictive hazard relationship. This simulation allows the system to generate a preventative instruction before a physical conflict occurs, effectively anticipating user error or environmental instability. This proactive reasoning ensures that the visual overlay (e.g., a red highlight or a directional arrow indicating a safer placement) is grounded in a simulated physical future, rather than just a static observation of the present.

In some implementations, the semantic reality system can be configured to reduce the prompting burden on the user by triggering context-aware AI queries without requiring explicit natural language queries from the user. In this context, a natural language query can refer to a traditional human-to-computer interaction where a user manually formulates and inputs a specific request (e.g., a typed text string or a deliberate spoken question) to retrieve information or initiate a task. Instead of forcing the user to stop their workflow to describe what they are looking at or what they need (e.g., speaking or typing "what does this Ethernet port do?"), some implementations can utilize a model configured to interpret natural physical interactions (e.g., a pointing gesture 115, grabbing an object (e.g., beverage container 135), or arranging items in a workspace) as implicit signals of intent. By fusing these actions with real-time environmental context and spatial mesh data, some implementations can automatically generate the necessary underlying prompts for the multimodal models, allowing digital assistance to surface proactively as the user engages with their physical surroundings.

Anchor module 215 can be configured to represent physical items as persistent digital entities, providing stable reference points for identifying individual objects and surfacing relevant information or actions. The anchor module 215 receives raw spatial and visual data from the sensor(s) 205 to establish these digital anchors within a 3D coordinate space. For example, the sensor(s) 205 can utilize a pass-through RGB camera to capture visual snapshots and depth sensors, such as LiDAR or time-of-flight sensors, to generate a spatial mesh of the physical environment. This can allow the anchor module 215 to perform 2D-to-3D re-projection and raycasting to determine the 3D coordinates for an object, such as a network router 120 or a potted plant 150, ensuring that digital overlays remain registered to the physical world even as the user moves.

Raycasting can be a computer vision and graphics technique used to determine the intersection of a conceptual ray with the geometric surfaces of a 3D scene. By calculating the trajectory of a ray from an origin point (e.g., a camera’s focal center) through a 2D coordinate on an image plane, the system can identify the point where that ray strikes the physical topology of the room. This process allows the semantic reality system to transform a user's 2D interaction, such as a fingertip position on a screen or a gaze vector, into a grounded 3D coordinate. For example, the anchor module 215 can utilize raycasting to bridge the gap between raw visual snapshots and the spatial mesh, ensuring that digital anchors and sub-anchors remain registered to physical objects even as the user’s perspective changes.

The anchor module 215 can support multi-level interaction by generating sub-anchors that persist within an object's local coordinate space. By processing tracking data from inward-facing and outward-facing infrared sensors, the system can monitor gaze fixation and hand positions to detect natural physical interactions like pointing or grabbing. For example, if the sensor(s) 205 captures an image representing a user's fingertip proximity to a specific Ethernet port on a router, the anchor module 215 can generate a localized sub-anchor to allow the user to engage with that specific sub-component. This data collection enables the system to provide detail-level assistance, such as performing optical character recognition (OCR) on fine-print nutritional labels or identifying specific mechanical parts and ports that would be inaccessible through broader object-level identification.

An anchor can be configured to represent physical items as persistent digital data, providing stable reference points for identifying individual objects and surfacing relevant information or actions. In an augmented reality (AR) environment, an anchor functions as a spatially registered coordinate system that allows digital content to remain fixed relative to a specific physical entity, even as the user moves or the environment changes. For example, in a medical training application, a digital anchor could be established for a physical anatomical model on a workbench; as a student rotates the model or walks around the table, the system uses the anchor to ensure that high-resolution labels and internal structural overlays remain precisely aligned with the corresponding physical parts, facilitating a consistent and interactive educational experience.

The anchor module 215 can be configured to manage a hierarchy of digital markers across multiple scales of interaction regarding the detail-level and object-level tiers of the system architecture. By processing data from the sensor(s) 205 (e.g., 2D bounding boxes from a pass-through camera and spatial geometry from depth sensors), the anchor module 215 can perform raycasting against a spatial mesh to determine 3D coordinates for each identified entity. At the object-level, the module establishes a digital anchor for a whole physical object, providing a reference point in a 3D coordinate space. At the detail-level, the anchor module 215 can generate sub-anchors for localized sub-components, such as specific ports, dials, or text regions. These sub-anchors can function as persistent digital markers that maintain a fixed position within the local coordinate space of the parent digital anchor. This hierarchical anchoring ensures that visual overlays remain registered to both the object as a whole and its specific sub-components even as the physical objects move within the environment, thereby enabling the system to compensate for spatial drift and maintain perceptual transparency during complex manual tasks.

ML module 220 can be configured to function as an intelligent middleware layer that processes raw environmental data and user interactions to facilitate context-aware assistance. ML module 220 can function as a multi-agent AI system, including specialized agents, such as a visual reasoning agent or a UI generation agent, that coordinate to interpret the physical scene. By ingesting data from the sensor(s) 205 and the environmental context module 210, the ML module 220 can recognize natural physical actions (e.g., pointing, grabbing, arranging objects, and/or the like) and expand these gestures into prompts for information retrieval. This architecture can reduce the prompting burden on the user by predicting needs and triggering proactive, nonverbal feedback, like visual highlights or relationship lines.

ML module 220 can receive a continuous stream of data from various sensors within the sensor(s) 205 to maintain an accurate world model. For example, RGB cameras and depth sensors (such as LiDAR or time-of-flight sensors) provide real-time visual snapshots and spatial geometry, allowing ML module 220 to identify objects, like a network router 120 or a smartphone 130, and map their 3D coordinates. Additionally, inward-facing and outward-facing infrared sensors collect data on gaze fixation and hand positions, enabling the ML module 220 to detect precise interactions with sub-components, such as a user pointing at a specific Ethernet port. This multimodal data allows the system to generate a real-time scene graph that interprets functional dependencies and predictive hazards, such as the risk of a beverage container 135 spilling onto a peripheral hard drive 145.

Further to the descriptions above, a user may be provided with controls allowing the user to make an election as to both if and when systems, programs, or features described herein can enable collection of user information (e.g., information about a user’s social network, social actions, or activities, profession, a user’s preferences, or a user’s current location), and if the user is sent content or communications from a server. In addition, certain data may be treated in one or more ways before it is stored or used, so that personally identifiable information is removed. For example, the system can implement a local-first privacy gateway within the ML module 220, where raw visual snapshots are processed into abstract semantic tokens and spatial meshes on the wearable device 110 before any data is transmitted to the second model 325. In some implementations, the first model and the second model can be a multi-modal model that includes the first model and the second model. This semantic scrubbing (e.g., processed on-device before the data reaches the cloud-based MLLM) can ensure that sensitive visual details (e.g., faces, framed photographs, or printed documents) are redacted or replaced with generic volumetric bounding boxes within the scene graph. Additionally, a user’s geographic location may be generalized where location information is obtained (such as to a city, ZIP code, or state level), so that a particular location of a user cannot be determined. Thus, the user may have control over what information is collected about the user, how that information is used, and what information is provided to the user.

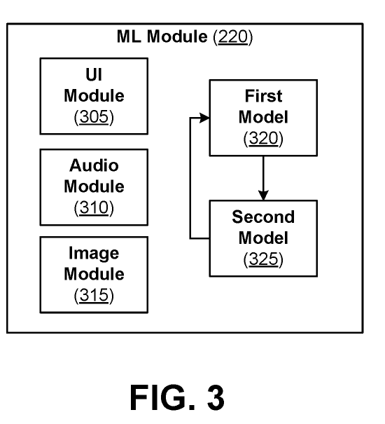

FIG. 3 illustrates a block diagram of ML module 220 of the semantic reality system architecture of FIG. 2. ML module 220 is organized into a nested modular framework consisting of multiple specialized sub-processing units. These units are arranged to handle different data modalities, including user interface elements, auditory inputs, and visual information. By partitioning the machine learning operations into these distinct functional blocks, the ML module 220 can concurrently process diverse environmental and interaction streams to support context-aware reasoning. This internal architecture allows the system to synthesize multi-sensory data, ensuring that the intelligent middleware can effectively interpret complex physical scenes and user intent.

ML module 220 can be configured to function as an intelligent middleware layer that processes raw environmental data and user interactions to facilitate context-aware assistance. ML module 220 can function as a multi-agent AI system, including specialized agents, such as a visual reasoning agent or a UI generation agent, that coordinate to interpret the physical scene. For example, the ML module 220 arrives at environmental inferences by first encoding spatial geometry into a high-dimensional embedding. By ingesting data from the sensor(s) 205 and the environmental context module 210, the ML module 220 converts 3D coordinates, object labels, and gesture duration into a multimodal vector. This vector is then processed by a first model 320, which utilizes a cross-attention mechanism to weigh the importance of a user's gesture (e.g., a pointing dwell time) against the identified object's functional metadata (e.g., 'Power Port'). This weighted analysis allows the system to expand simple gestures into sophisticated prompts for information retrieval by predicting the user's likely objective within a specific task graph. This architecture can reduce the prompting burden on the user by predicting needs and triggering proactive, nonverbal feedback, like visual highlights or relationship lines.

UI module 305 can be configured to manage the generation and adaptation of augmented reality interface elements based on the hierarchical interaction architecture. In some implementations, UI module 305 can function as a specialized agent within the intelligent middleware, translating semantic reasoning and object relationships into spatially registered visual feedback. By processing data from the interaction module 225, UI module 305 can determine the appropriate visual representation for a given scale of interaction, such as rendering a high-precision callout for a sub-anchor or a connectivity graph for environment-level dependencies. UI module 305 can ensure perceptual transparency by providing nonverbal feedback that predicts user needs, effectively reducing the prompting burden by surfacing information through natural physical actions rather than explicit text queries.

The UI module 305 can utilize a variety of data types to construct a context-aware digital overlay, including 3D transform data, semantic labels, and relationship metadata. For example, in consumer electronics troubleshooting scenarios, the UI module 305 can ingest 2D bounding boxes and 3D coordinates to generate a dashed rectangular callout (sub-anchor) around a specific Ethernet port on router 120. In an educational biology context, UI module 305 can process ingredient lists or nutritional data identified through optical character recognition (OCR) to display a summarized information card over a botanical specimen. Further, the UI module 305 can leverage dependency vectors from the scene graph to render relationship lines, such as a curved path connecting a beverage container 135 to a peripheral hard drive 145, thereby visualizing predictive hazards or functional workflows directly within the user’s field of view.

Audio module 310 can be configured to process auditory inputs and generate speech-based interactions within the semantic reality system. In some implementations, audio module 310 can function as a specialized processing unit that translates natural language speech into structured data for environmental reasoning and information retrieval. The data processed by the audio module 310 can include raw waveform data, phonemic sequences, and semantic text strings derived from a speech-to-text (STT) component. For example, in a laboratory configuration task, audio module 310 can ingest a user’s spoken query, such as “How do I connect these two parts?” while the user is performing a pointing gesture 115. To facilitate a theory of mind interaction, the audio module 310 can perform fluid disambiguation by cross-referencing linguistic references (e.g., the pronouns "them" or "these") with the active selection state of digital anchors in the scene graph.

By identifying which objects are currently highlighted or selected in the spatial coordinate space, the audio module 310 can be configured to extract the intent and pairs this data with the spatial context provided by the scene graph. This enables the system to identify the specific entities involved in a functional relationship and retrieve information (e.g., assembly steps, compatibility data, and/or the like), to be displayed as a visual overlay. Additionally, the audio module 310 can process auditory metadata to support voice Q&A interactions, allowing the system to provide real-time, context-aware responses to open-ended questions about object attributes or environmental hazards.

The data processed by the audio module 310 can include raw waveform data, phonemic sequences, and semantic text strings derived from a speech-to-text (STT) component. For example, in a laboratory configuration task, audio module 310 can ingest a user’s spoken query, such as "How do I connect these two parts?" while the user is performing a pointing gesture 115. The audio module 310 can extract the intent and identify linguistic references to objects (e.g., the use of pronouns like "them" or "these") and pair this data with the spatial context provided by the scene graph. This enables the system to identify the specific entities involved in a functional relationship and retrieve information, such as assembly steps or compatibility data, to be displayed as a visual overlay. Additionally, the audio module 310 can process auditory metadata to support voice Q&A interactions, allowing the system to provide real-time, context-aware responses to open-ended questions about object attributes or environmental hazards.

Image module 315 can be configured to perform high-level scene understanding and object recognition by processing visual data from the sensor(s) 205. In some implementations, image module 315 can function as a visual perception engine that identifies physical entities and their spatial boundaries, enabling the system to treat real-world objects as interactable digital entities. By analyzing incoming RGB-D frames, the image module 315 can generate semantic labels and 2D bounding boxes for objects within the user’s field of view, which are then passed to the anchor module 215 for 3D re-projection. Image module 315 can be configured to generate the data used for the detail-level, object-level, and environment-level scales of interaction, as it provides the raw classification used to differentiate between a localized sub-component and a broader functional group.

The data utilized by the image module 315 can include a continuous stream of visual snapshots and spatial geometry, typically captured at a regular sample rate, such as every 10 seconds. For example, in a laboratory or home office setting, the image module 315 processes image data to identify a variety of objects, such as a network router 120, a smartphone 130, or a beverage container 135. Image module 315 can extract visual features and candidate labels, such as identifying a laptop or a potted plant, and provides the metadata used to detect natural physical interactions, like a pointing gesture 115 directed at a sub-component. Further, the image module 315 can collect the environmental context to identify potential predictive hazards, such as the proximity of a liquid container to an electronic device, by providing the spatial meshes and object boundaries used to establish functional relationships in a scene graph.

In some implementations, ML module 220 can be implemented as a multi-agent AI system, including one or more specialized machine-learned models. For example, the image module 315 may utilize a computer vision model, such as the Segment Anything Model (SAM), for precise object boundary identification, or a vision transformer (ViT) for generating 2D bounding boxes and semantic labels from RGB-D frames. These visual outputs can be processed by intelligent middleware, which may include a multimodal large language model (MLLM) functioning as a visual reasoning agent to interpret the functional relationships and relational meaning between identified objects. To facilitate natural interaction, the audio module 310 may employ a speech-to-text (STT) transformer model to parse voice queries, while the UI module 305 may function as an executor agent that translates the MLLM’s structured reasoning into spatially registered AR interface elements. By coordinating these models, the system can expand a physical gesture, such as a pointing highlight, into a natural language prompt for information retrieval, effectively reducing the prompting burden on the user.

As shown in FIG. 3, ML module 220 is implemented as a multi-agent AI system, including a first model 320 and a second model 325. The first model 320 can be configured as a prompt expansion agent that receives raw interaction signals from the UI module 305, the audio module 310, or the image module 315. For example, the first model 320 can expand a user-initiated physical interaction (e.g., a sentence-length voice query or a pointing gesture) into a sophisticated, paragraph-length natural language instruction set by synthesizing the interaction with environmental metadata from the scene graph.

The second model 325 can be configured as an information retrieval agent that receives the expanded instruction set from the first model 320. The second model 325 can be configured to process this instruction set against a broader knowledge base to retrieve task-relevant intelligence, such as technical specifications, assembly steps, or hazard warnings. A bidirectional communication path between the first model 320 and the second model 325 facilitates a critique and refinement loop, where the first model 320 can evaluate the output of the second model 325 for contextual accuracy and request iterative refinements until the retrieved information meets a specified relevance threshold. By partitioning these roles, the system can reduce the prompting burden on the user, allowing simple embodied actions to trigger high-complexity information retrieval and generate precisely calibrated visual overlays.

Returning to FIG. 2, interaction module 225 can be configured to function as the distribution and categorization processor for environmental and user data processed by the ML module 220. Interaction module 225 can be configured to parse the multimodal inputs (e.g., including spatial meshes, object labels, and user gestures) into a structured hierarchy of interaction scales. By evaluating the intent and precision of a user’s physical actions, the interaction module 225 can direct the flow of information to the appropriate tier of the system’s semantic architecture. This allows the system to differentiate between a broad query about a workspace and a high-precision interaction with a specific sub-component, ensuring that the resulting digital assistance is calibrated to the user's current level of focus.

In some implementations, data managed by the interaction module 225 can include real-time telemetry and semantic metadata derived from the physical environment. For example, the interaction module 225 can process 3D coordinate data representing the proximity of a user’s fingertip to a digital anchor, such as a network router 120, alongside temporal stability metrics to determine if a gesture constitutes a stable selection. Additionally, the interaction module 225 can utilize relationship data from the scene graph, such as dependency vectors between a smartphone 130 and a laptop 125, to identify when a user is attempting an inter-object workflow. By synthesizing these data points, the interaction module 225 can trigger context-specific prompts, such as identifying a predictive hazard between a beverage container 135 and a peripheral hard drive 145 or surfacing technical specifications for a localized Ethernet port.

This hierarchical filtering ensures that the system provides contextually relevant digital assistance aligned to the user's specific level of focus, effectively bridging the gap between raw sensor data and actionable environmental reasoning. Further, the interaction module 225 can utilize relationship data and dependency vectors from the scene graph to identify inter-object workflows, triggering proactive feedback such as relationship lines or predictive hazard warnings when the spatial context suggests a functional or risky connection between multiple entities.

The detail level module 230 is configured to process fine-grained spatial and visual data to identify features that are otherwise inaccessible through broader object-level identification. By analyzing data such as fingertip proximity and gaze stability, this module enables the system to establish precise "sub-anchors" within an object's coordinate space. This allows for the persistent registration of digital overlays—such as technical labels, translated text, or functional descriptions—directly onto specific sub-regions of a device or item, ensuring that the information remains correctly aligned even if the parent object is moved or rotated.

The data utilized by the detail level module 230 primarily consists of high-resolution visual snapshots and localized 3D coordinate data derived from the sensor(s) 205. For example, in a consumer electronics configuration scenario, the module processes image data of a network router 120 to perform optical character recognition (OCR) on fine-print port labels or to identify the specific geometry of an Ethernet port. In a medical or nutritional context, the module may ingest data from a magnified view of a supplement container to extract and summarize ingredient lists or warning text. By synthesizing this granular data with real-time hand-tracking telemetry, the detail level module 230 can provide the technical foundation for hover experiences and gesture-based queries, effectively bridging the gap between a complex physical interface and situated digital assistance.

The object level module 235 can be configured to represent physical items as persistent digital anchors, providing stable reference points for identifying individual objects and surfacing relevant information or actions. In some implementations, object level module 235 can operate at a second scale of interaction, focusing on the digital representation of a whole physical object rather than its localized sub-components. By processing data from the interaction module 225, the object level module 235 maintains a consistent identity and spatial positioning for objects within the user’s physical environment. For example, when a user selects or interacts with an object, such as by picking up a condiment jar or gazing at a smartphone 130, the object level module 235 can trigger the retrieval of contextually relevant suggestions or attributes specific to that entire entity, facilitating a stable foundation for situated learning.

The data utilized by the object level module 235 can include 3D coordinates derived from raycasting against a spatial mesh, object identifiers, and semantic labels or categories. For example, in a consumer electronics scenario, the object level module 235 can process metadata to identify a network router 120 or a laptop 125, enclosing them in thin-lined 3D bounding boxes that serve as digital anchors. These anchors store state information, such as whether an object is currently selected or highlighted, and are automatically refined when more specific descriptors become available (e.g., updating a generic container label to a specific Funky-Cola can). By maintaining this persistent metadata and 3D transform data, the object level module 235 can ensure that digital information remains registered to the physical world even as objects are moved or the user’s perspective changes.

The environment level module 240 can be configured to interpret the functional relationships and relational meaning between multiple objects within the physical environment. In some implementations, environment level module 240 can operate at a third scale of interaction (e.g., the semantic layer) to generate a real-time scene graph that maps how various entities relate to one another within a broader workflow or task context. By analyzing spatial distribution and identified categories of objects (e.g., a smartphone 130 and a router 120), the environment level module 240 can identify dependencies that are not apparent at the individual object level. This allows the system to provide proactive, nonverbal feedback, such as relationship lines or connectivity graphs that remain registered to the physical world, helping the user understand what goes with what in complex scenarios like electronic configuration or laboratory assembly.

The data utilized by the environment level module 240 can include structured environmental metadata, 3D coordinate data from the spatial mesh, and dependency vectors derived from the machine learning module 220. For example, the environment level module 240 can process identified scene types (e.g., an office or kitchen) to prioritize likely tasks and functional connections, such as identifying a grouping relationship between a set of baking ingredients or a sequential relationship for a multi-step hardware installation. In some implementations, this data processing is the identification of predictive hazard relationships. For example, if the sensor(s) 205 detect a beverage container 135 within a specific proximity threshold of a peripheral hard drive 145, the environment level module 240 can identify the risk and surface a preventative instruction. By synthesizing these relational data points into a coherent scene graph, the module enables the system to foresee or predict user needs and provide situated assistance that reflects a theory of mind regarding the physical environment.

Visual overlay module 245 can be configured to synthesize the data from the detail level module 230, the object level module 235, and the environment level module 240 into a coherent digital representation. In some implementations, visual overlay module 245 can function as the final output stage of the system, transforming the hierarchical semantic reasoning into spatially registered AR content displayed on the wearable device 110. By integrating the different scales of interaction, the visual overlay module 245 can ensure perceptual transparency, allowing the user to see what the model perceives and how it intends to provide situated assistance. This can be achieved by rendering nonverbal feedback, such as 3D bounding boxes for objects and callouts for sub-components, which remain anchored to the physical world even as the user moves or objects are manipulated.

The data processed and displayed by visual overlay module 245 can include various forms of actionable intelligence derived from the multi-level interaction architecture. At the detail level, the visual overlay module 245 can render localized overlays such as technical specifications for an Ethernet port or OCR-summarized nutritional data from a product label. At the object level, visual overlay module 245 can generate persistent digital anchors, often visualized as thin-lined 3D bounding boxes, which surface suggested actions or identity labels, like, for example, “cola can”. At the environment level, the visual overlay module 245 can render relationship lines and connectivity graphs that illustrate functional dependencies between multiple entities, such as a line connecting a smartphone 130 to a router 120. Further, the visual overlay module 245 can be configured to display preventative instructions and visual highlights associated with predictive hazard relationships, such as a warning to move a beverage container 135 away from a peripheral hard drive 145 to avoid liquid damage.

The system can be configured to identify a first object in a physical environment at a first scale of interaction, where the first scale of interaction corresponds to a sub-component of the first object. A scale of interaction can refer to a specific tier of a semantic hierarchy that defines the level of spatial and conceptual granularity at which the system processes environmental data. A sub-component can refer to a localized feature, part, or region of a larger physical entity that possesses its own distinct semantic identity or functional purpose, such as a specific port, a button, a dial, or a delimited text block on a label. For example, the system can identify an Ethernet port on the rear housing of a network router 120. In some implementations, identifying the first object at the first scale of interaction can include detecting a detail-level engagement, which can focus processing resources on a localized subregion of the physical object to enable high-precision digital anchoring.

The system further identifies a second object in the physical environment at a second scale of interaction. The second scale of interaction can correspond to an object-level focus, which can treat a physical item as a single, unified digital entity rather than a collection of parts. In this context, an object-level identification can include defining the global boundaries of a discrete item, such as a smartphone 130 or a laptop 125, and establishing a persistent digital anchor that represents the entire entity within a 3D coordinate space. This scale of interaction can allow the system to retrieve information related to the object’s general attributes, identity, or state without requiring the granular precision used for sub-component analysis.

Additionally, the system identifies a third object in the physical environment at a third scale of interaction, where the third scale corresponds to a functional relationship between the third object and at least one of the first object or the second object. A third scale of interaction can refer to an environment-level or semantic layer that interprets the inter-object dependencies within a scene. A functional relationship can refer to a logical, operational, or causal link between two or more objects that defines how they interact or relate within a specific task or workflow. For example, the system can identify a connectivity relationship between a router (the first object) and a monitor 140 (the third object), or a safety relationship between a beverage container 135 and a peripheral hard drive 145.

In some implementations, identifying the functional relationship can include categorizing the relationship into a taxonomy of semantic structures. This taxonomy can include a grouping relationship representing a set of related objects (e.g., a set of tools), a parallel relationship representing interchangeable or alternative objects (e.g., two different compatible power cables), and/or a sequential relationship representing a task-based order of operations (e.g., a multi-step assembly process). By identifying these relationships at the environment-level, the system generates a scene graph (e.g., a structured digital map of the physical workspace) that encodes the relational meaning and/or contextual dependency between a plurality of physical objects.

The system utilizes a first model (e.g., model 320) to generate a prompt based on the identified first object, second object, and third object. A prompt can refer to a structured data input, such as a natural language instruction set, that encapsulates environmental context and user intent to guide the reasoning of a subsequent model. The first model can function as a prompt expansion agent and/or intelligent middleware that transforms raw interaction signals (e.g., a pointing gesture, a simple gaze fixation, and/or the like) into a sophisticated query. This expansion process can reduce the prompting burden on the user by automatically synthesizing object identifiers, 3D transforms, and relational metadata from the scene graph into a paragraph-length instruction for information retrieval.

A second model (e.g., model 325) can then be utilized to retrieve information based on the prompt generated by the first model. The information can refer to task-relevant intelligence, such as technical specifications, assembly instructions, hazard warnings, or real-time status updates, sourced from a knowledge base or through generative reasoning. For example, if the prompt identifies a user pointing at a WAN port (sub-component) and a nearby modem (third object), the second model can retrieve the specific cabling steps required to establish an internet connection between those two entities. The first and second models can operate as a multi-agent system where the first model critiques or refines the instructions to ensure the second model provides the most contextually accurate response.

Following information retrieval, the system displays a visual overlay based on the information. A visual overlay can refer to a spatially-registered digital graphic, such as a 3D bounding box, a callout, a highlight, or a relationship line, rendered on a wearable device. To ensure perceptual transparency, the overlay can be spatially-locked or anchored to the physical coordinates of the objects, meaning it remains fixed to the items even if the user moves or the objects are manipulated. For example, a relationship line may be rendered as a dashed curved path connecting a smartphone to a router, visually representing the functional dependency identified at the environment-level.

In an example implementation, a user wearing smart glasses approaches a workbench containing a disassembled computer. The system identifies a “reset jumper” (first object) at a detail-level (first scale of interaction) because the user’s fingertip is within a proximity threshold of the jumper. Simultaneously, the system identifies the “motherboard” (second object) at an object-level (second scale) and a “manual” (third object) resting nearby. The system identifies a sequential relationship (functional relationship) between the jumper and the motherboard. The first model generates a prompt: “The user is interacting with the reset jumper on a Model-Y motherboard; retrieve the correct pin configuration for a hard reset.” The second model retrieves the pin diagram, and the system displays a visual overlay (a high-precision callout) registered to the sub-anchor of the jumper pins.

The identification of these objects and relationships is often triggered by a user intent cue, which is a detectable physical signal of engagement. A user intent cue can include at least one of, for example, a fingertip proximity threshold (e.g., the distance between a finger and a surface), a gesture stability duration (e.g., how long a gesture is held), or a gaze fixation metric (e.g., the focus and duration of the user’s eyes). By filtering these cues through the semantic hierarchy, the system can automatically distinguish between a user simply looking at a desk (environment-level) and a user precisely pointing at a specific mechanical part (detail-level), thereby ensuring the digital assistance is calibrated to the user's current focus.

Further, the system can identify a predictive hazard relationship at the environment-level. A predictive hazard can refer to a potential physical conflict or risk identified by simulating the consequences of the current environmental state, such as a liquid container being placed near electronics. In such cases, the information retrieved by the second model can include a preventative instruction (e.g., a proactive warning or guidance intended to forestall a negative physical outcome). For example, the visual overlay may appear as a red highlight on a coffee cup 135 with a text prompt: “Move liquid away from the hard drive to prevent spill damage,” effectively establishing a theory of mind regarding the physical safety of the workspace.

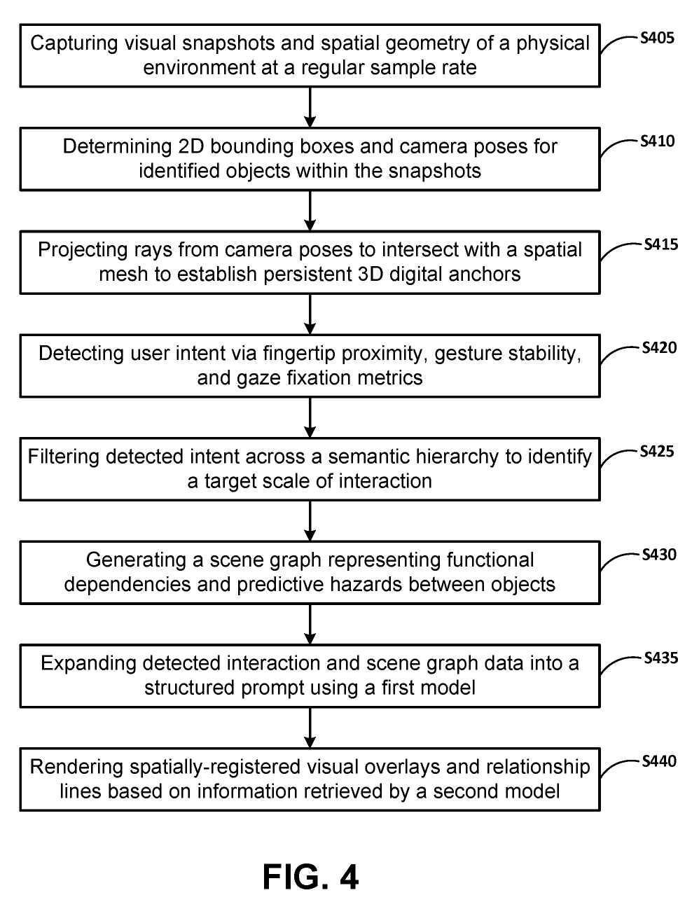

FIG. 4 illustrates an example method for transforming raw environmental data into context-aware digital assistance through a multi-stage processing pipeline. The process begins with the continuous capture of visual and spatial data from the physical environment, which is used to identify objects and establish persistent digital anchors within a three-dimensional coordinate space. By monitoring user metrics such as gaze and gesture stability, the system detects specific interaction intents and filters them through a semantic hierarchy to determine the appropriate scale of engagement (e.g., whether at the detail, object, or environment level). This information is synthesized into a real-time scene graph that maps functional dependencies and potential hazards, which then serve as the basis for generating sophisticated prompts for information retrieval. The method concludes by rendering visual overlays and relationship lines, ensuring that the retrieved intelligence is presented as an intuitive, nonverbal addition to the user's physical reality.

As shown in FIG. 4, in step S405, visual snapshots and spatial geometry of a physical environment are captured at a regular sample rate. In some implementations, this step can function as the data acquisition layer for the semantic reality system, utilizing the sensor(s) 205 to monitor the user’s surroundings. By capturing these snapshots periodically (e.g., every 10 seconds), the system can maintain a persistent and up-to-date visual record of the workspace, including, for example, the appearance and orientation of various physical entities. Substantially simultaneously, the acquisition of spatial geometry via depth-sensing hardware can allow the system to generate a 3D mesh of the environment, providing the coordinate framework for anchoring digital information to real-world coordinates.

In an example implementation of step S405, a head-mounted display (HMD) (e.g., wearable device 110) equipped with a pass-through RGB camera and LiDAR sensors can continuously stream environmental data to the environmental context module 210. As the user moves through, for example, a laboratory or office, the RGB camera captures high-resolution frames that include fine-grained details, such as the text on a supplement label or the specific ports on network router 120. Further, the LiDAR sensor pulses infrared light to calculate the distance to surfaces, creating a point cloud that defines the boundaries of the desk, walls, and objects. This dual-stream capture ensures that the ML module 220 has access to both the semantic content (what the objects are) and the spatial context (where the objects are), enabling the system to later identify interactions at the detail-level, object-level, and environment-level.

In step S410, 2D bounding boxes and camera poses are determined for identified objects within the snapshots. For example, the image module 315 processes the raw RGB-D frames to perform open-vocabulary object detection, localizing physical entities and defining their initial spatial boundaries. By generating a 2D bounding box for each candidate object (e.g., network router 120, a smartphone 130, and/or the like), the system establishes a preliminary digital footprint for the items in the user’s field of view. Further, the system can retrieve and store the camera pose, representing the position and orientation of the HMD. This synchronization of visual identification with spatial orientation can ensure that any subsequent digital overlays remain registered to the physical world, even if the user’s perspective changes after the frame is captured.

In some implementations, the ML module 220 can utilize a vision transformer or a detection model to analyze a snapshot of a multifaceted workspace. If the sensor(s) 205 captures an image containing a laptop 125 and a peripheral hard drive 145, the system can calculate the pixel-level coordinates for a bounding box that encloses each device. For the hard drive 145, the system can identify a candidate label such as “electronic peripheral” while recording a camera pose defined by a six-degree-of-freedom (6DoF) vector. This data collection can allow the interaction module 225 to later differentiate between a broad object-level interaction and a high-precision detail-level interaction (e.g., pointing gesture 115) directed at a sub-component, such as a specific data port. By maintaining this coupling between 2D image data and 3D camera telemetry, the system can create the technical foundation for performing 2D-to-3D re-projection and raycasting in the subsequent stages of the semantic hierarchy.

In step S415, rays are projected from camera poses to intersect with a spatial mesh to establish persistent 3D digital anchors. For example, the anchor module 215 utilizes the 2D bounding boxes and 6DoF camera poses determined in the previous step to calculate the precise longitudinal and latitudinal coordinates of objects in 3D space. By performing 2D-to-3D re-projection and raycasting against the environmental spatial mesh, the system transforms a flat visual snapshot into a spatially aware digital twin. This process ensures that identified entities, whether a whole object or a localized sub-component, can be assigned a fixed coordinate within the HMD’s tracking universe, effectively anchoring digital information to the physical world with high spatial fidelity.

In some implementations, the system identifies a sub-component (e.g., an Ethernet port) of an object (e.g., network router 120) and casts a ray from the HMD’s recorded camera pose through the center of the port’s 2D bounding box. When the ray intersects with the spatial mesh generated by the LiDAR sensors, the anchor module 215 can generate a sub-anchor at that intersection point. This sub-anchor can function as a persistent digital marker that maintains a fixed position within the local coordinate space of the router's primary digital anchor. Therefore, if the user moves their head or physically manipulates the router, the sub-anchor remains registered to the specific port, allowing the system to maintain perceptual transparency by keeping technical overlays pinned to the correct mechanical part without experiencing spatial drift.

To ensure the temporal and spatial stability of the digital overlays, the system can be configured to implement a continuous drift compensation mechanism. This process involves the anchor module 215 performing a real-time reconciliation between the device’s Visual-Inertial Odometry (VIO) data and the persistent scene graph. For example, the system captures visual snapshots at a regular sample rate and extracts a set of high-entropy visual features (e.g., corner points or high-contrast edges) from the physical environment. These features are compared against the previously stored 3D coordinates of the digital anchors to calculate a transform offset. If the Euclidean distance between a detected physical feature and its corresponding digital anchor exceeds a predefined drift threshold, the ML module 220 calculates a recalibration matrix to re-align the 3D coordinate space. This ensures that a visual overlay, such as a relationship line or a sub-anchor on a network router 120, does not 'float' away from its physical referent as the user moves through the environment, thereby maintaining the perceptual transparency required for high-precision manual tasks.

Raycasting can be a computer vision and graphics technique used to determine the intersection of a conceptual ray with the geometric surfaces of a 3D scene. By calculating the trajectory of a ray from an origin point (e.g., a camera’s focal center) through a 2D coordinate on an image plane, the system can identify the point where that ray strikes the physical topology of the room. This process allows the semantic reality system to transform a user's 2D interaction, such as a fingertip position on a screen or a gaze vector, into a grounded 3D coordinate. For example, the anchor module 215 can utilize raycasting to bridge the gap between raw visual snapshots and the spatial mesh, ensuring that digital anchors and sub-anchors remain registered to physical objects even as the user’s perspective changes.

In step S420, user intent is detected via fingertip proximity, gesture stability, and gaze fixation metrics. For example, this step can represent the sensing layer for human-computer interaction within the semantic reality system, where the sensor(s) 205 collect high-frequency telemetry to interpret a user’s physical engagement with the environment. By monitoring the distance between a user’s fingertip and the surface of a digital anchor, alongside the duration and steadiness of a pointing or grasping gesture, the system identifies the specific spatial coordinates of the user's focus. Gaze fixation metrics can also be analyzed to confirm that the user’s visual attention aligns with their manual actions, providing a multimodal verification of intent. This process allows the system to trigger AI-driven assistance based on natural, embodied actions rather than requiring the user to formulate an explicit natural language query.

In some implementations, a user wearing a head-mounted display (e.g., wearable device 110) can perform a pointing gesture (e.g., pointing gesture 115) toward an object (e.g., network router 120). The system’s inward-facing infrared sensors track the user’s gaze to determine they are looking at the back of the device, while outward-facing cameras and depth sensors calculate the 3D coordinates of the user’s index finger. If the system detects that the fingertip remains within a specific proximity threshold (e.g., within 2 centimeters) of a localized object (e.g., Ethernet port) for a stable duration (e.g., 500 milliseconds), it classifies the interaction as a high-precision intent directed at a sub-component. This quantitative analysis of physical metrics can provide the data used for the interaction module 225 to distinguish between a general interest in the object and detail-level information, such as the port’s technical configuration or status.

In step S425, detected intent is filtered across a semantic hierarchy to identify a target scale of interaction. For example, this step can function as the logic gate of the interaction module 225, where the system categorizes the telemetry and spatial coordinates into one of three distinct tiers: detail-level, object-level, or environment-level. By evaluating the precision and stability of the user's physical engagement (e.g., such as the proximity of a fingertip to a specific sub-component versus a broad grasping gesture around a whole entity), the system can determine the appropriate scales of interaction (e.g., levels of granularity) for digital assistance. This hierarchical filtering can ensure that the resulting queries (e.g., AI queries) are calibrated to the user’s specific level of focus, effectively bridging the gap between embodied physical action and situated digital intelligence.

In some implementations, the interaction module 225 can receive data indicating that a user’s gaze and fingertip are focused on a localized subregion of an object (e.g., network router 120). If the spatial coordinates of the fingertip fall within a high-precision threshold of a sub-object (e.g., an Ethernet port) and remain stable for a threshold temporal duration, the system filters this intent as a detail-level interaction. Conversely, if the user performs a broad pinch gesture while gazing at the object (e.g., network router 120) as a whole, the system identifies the target scale as an object-level interaction. Furthermore, if the system detects the user moving multiple objects in relation to one another, it identifies an environment-level scale to surface relational meaning or functional dependencies. By dynamically identifying the target scale of interaction in this manner, the system reduces the prompting burden on the user, allowing for context-aware feedback without receiving a natural language text query.

In step S430, a scene graph representing functional dependencies and predictive hazards between objects is generated. For example, the environment level module 240 can synthesize the spatial coordinates, object labels, and semantic metadata to map the relational meaning between a plurality of physical entities. By evaluating the relative positions of objects within the 3D coordinate space against a knowledge graph or multimodal model, the system identifies how objects affect one another within a broader workflow. This environment-level interaction allows the system to move beyond isolated object identification to understand the theory of mind for sophisticated task assistance, such as identifying a sequential relationship for an assembly process or a grouping relationship for related tools.

In some implementations, the environmental context module 210 analyzes the spatial mesh to detect the proximity of an object (e.g., beverage container 135) to another object (e.g., peripheral hard drive 145). If the distance between these two digital anchors falls below a safety threshold, the system identifies a predictive hazard relationship, indicating, for example, a risk of liquid damage to the electronic component. Further, the system can identify a functional dependency between an object (e.g., network router 120) and another object (e.g., smartphone 130), establishing a connectivity relationship in the scene graph. This structured representation of the environment enables the interaction module 225 to provide proactive, nonverbal feedback, such as relationship lines that visualize these dependencies, effectively lowering the entry point for a user to understand and navigate a complex or unfamiliar physical workspace.

In step S435, detected interaction and scene graph data can be expanded into a structured prompt using a first model. For example, this step can represent the intelligent middleware or multi-agent orchestration layer of the semantic reality system, where raw spatial and semantic metadata can be transformed into a natural language instruction set. By synthesizing the identified scale of interaction (e.g., detail-level) with the functional dependencies of the scene graph (e.g., a sequential relationship), the first model functions as a prompt-engineered agent that reduces the prompting burden on the user. Instead of requiring an explicit natural language text query, the system automatically formulates a high-context query that accounts for object identifiers, 3D positions, and user intent, effectively bridging the gap between embodied physical action and large language model (LLM) knowledge.

In some implementations, if the system detects a detail-level interaction (e.g., pointing gesture 115) directed at a sub-object (e.g., a specific port) on an object (e.g., network router 120) and identifies a sequential relationship to another object (e.g., smartphone 130) in the scene graph, the first model (e.g., a specialized LLM agent) generates a structured prompt, such as, for example: "The user is pointing at the WAN port of a Model-X Router. Provide step-by-step instructions to connect this port to the identified smartphone 130 for initial gateway configuration." This process can include the first model criticizing or improving an initial brief internal signal to ensure the second model receives paragraph-length, high-quality instructions. By expanding a simple pointing gesture into a detailed query that includes the environment around the context and detected objects, the system can ensure that the information retrieved is highly relevant to the user's specific task and physical orientation.

In step S440, spatially registered visual overlays and relationship lines are rendered based on information retrieved by a second model. For example, the high-level semantic reasoning and multi-agent orchestration can be transformed into an intuitive, nonverbal interface on the HMD (e.g., wearable device 110). By utilizing the 3D coordinates and persistent digital anchors established in previous steps, the visual overlay module 245 ensures that digital content remains precisely pinned to the physical environment. This perceptual transparency allows the user to see how the AI interprets the workspace, providing proactive assistance through visual highlights, informational callouts, and connectivity graphs that facilitate situated learning and task completion.

In some implementations, the system can receive a natural language instruction set from the first model and query a second model (e.g., multimodal model) to retrieve technical data or functional guidance. If the scene graph identifies a sequential relationship for a hardware assembly, the visual overlay module 245 renders a series of dashed relationship lines connecting the relevant objects in the physical environment. For a detail-level interaction (e.g., pointing gesture 115) directed at a sub-object (e.g., a specific Ethernet port), the system can display a localized sub-anchor overlay containing OCR-derived technical specifications. Additionally, if a predictive hazard relationship is identified (e.g., the risk of a beverage container 135 spilling onto a peripheral hard drive 145), the system renders a preventative instruction and a visual warning highlight. This spatially registered feedback ensures that the retrieved information is presented in context, effectively lowering the entry point for users to navigate complex or unfamiliar environments without requiring explicit natural language text queries.

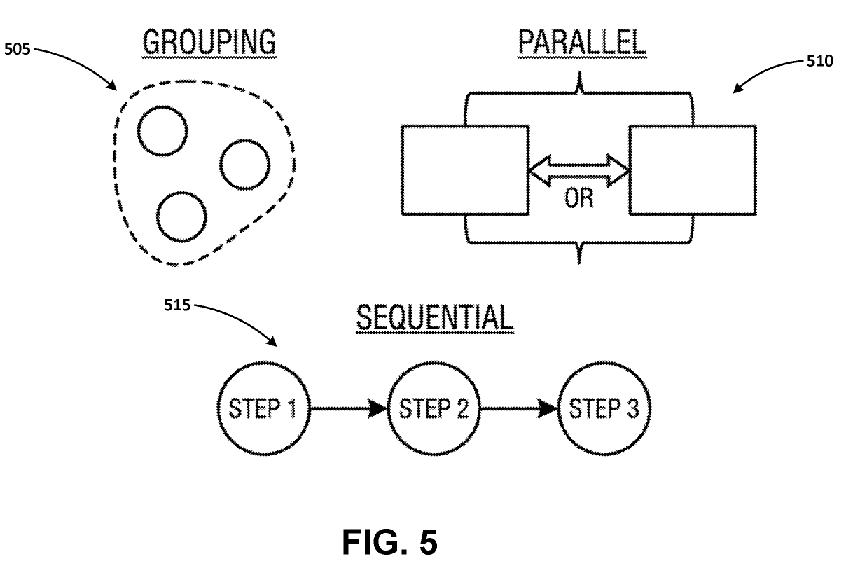

FIG. 5 illustrates a block diagram showing the semantic reality system categorizes identified functional relationships into a taxonomy of semantic structures, enabling the environment-level interaction layer to represent complex inter-object dependencies. This classification allows intelligent middleware to move beyond simple object tagging by interpreting the logical and operational links between a plurality of physical entities. By organizing environmental data into specific relationship types (e.g., grouping, parallel, and sequential structures), the system can generate contextually appropriate visual overlays, such as relationship lines or connectivity graphs, that remain registered to the physical objects in the 3D coordinate space.

The first relationship type, illustrated as grouping 505, represents a collection of related objects that are visually clustered without implying a specific order or hierarchy. In this configuration, the system identifies a set of items that share a common theme or functional context, such as a collection of tools in a repair kit or a group of baking ingredients on a kitchen counter. This grouping is visualized through a dashed-line boundary that encloses the digital anchors of the related objects, providing a non-verbal cue that these items should be considered a single logical unit for the current task.

The second relationship type, illustrated as parallel 510, represents interchangeable or alternative items that serve a similar function within a workflow. This structure is depicted as two rectangular boxes connected by a double-headed arrow with an "OR" logical operator centered between them. In a real-world implementation, such as a student choosing between different fertilizers for a plant project or a consumer comparing compatible power cables for a router 120, the system highlights these parallel options to facilitate decision-making. By surfacing these alternatives, the system reduces the prompting burden on the user, who can compare technical specifications or compatibility data without manually querying each individual item.

In some implementations, ML module 220 resolves this "OR" statement by applying a multi-factor prioritization heuristic to the identified parallel objects. This heuristic evaluates real-time environmental data (e.g., a state of health metric (e.g., identifying which of two parallel power cables has less physical wear), a readiness metric (e.g., identifying which of two fertilizers is currently uncapped), a proximity metric (e.g., identifying which compatible HDMI cable is already gripped by the user), and/or the like). By surfacing the most contextually viable alternative as the primary recommendation, the system reduces the prompting burden on the user, who can proceed with the optimal component without manually querying the specifications of every redundant item in the scene. This logical resolution allows the second model 325 to tailor the visual overlay to the most efficient task path, effectively streamlining decision-making in high-density physical environments.

The third relationship type, illustrated as sequential 515, represents a task-based order of operations where objects are linked in a prescribed step-by-step progression. This structure can be visualized as a linear path of circular nodes labeled "STEP 1", "STEP 2", and "STEP 3", connected by unidirectional arrows. In some implementations, the system generates an allocentric task topology (e.g., a birds-eye or non-egocentric view of the scene graph) to provide the user with foresight regarding upcoming steps. This sequential logic can be used for guided assembly or configuration tasks, such as the cabling of a network gateway or the multi-step setup of a laboratory experiment. By mapping these functional dependencies into a directed scene graph and surfacing them as a global task map, the system can provide proactive instructions and agency, allowing the user to understand not just what an object is, but where it fits into the broader temporal and spatial flow of a physical task, thereby improving long-term skill acquisition and memory retention.

To facilitate the categorization of the functional relationship at the environment-level, the environmental context module 210 can be configured to apply a relational taxonomy based on semantic affordance matching and spatiotemporal clustering. For example, the system identifies a grouping relationship 505 by detecting a plurality of objects that share a common task-specific metadata tag (e.g., fasteners) and reside within a defined proximity threshold of one another in the 3D coordinate space. A parallel relationship 510 is identified by the ML module 220 comparing the functional affordances of a first object and a second object against a library of interchangeable components; if the objects provide redundant utility within a detected workflow (e.g., two different HDMI cables), they are represented as alternative nodes in the scene graph. A sequential relationship 515 is derived by mapping the identified objects against an allocentric task topology, which defines a directed acyclic graph (DAG) of dependencies for a specific assembly or configuration procedure. This taxonomy allows the first model 320 to generate a prompt that accounts for the logical state of the environment (e.g., whether a prerequisite step has been completed) rather than just the physical presence of objects, thereby providing the second model 325 with the necessary context to retrieve step-accurate instructions.

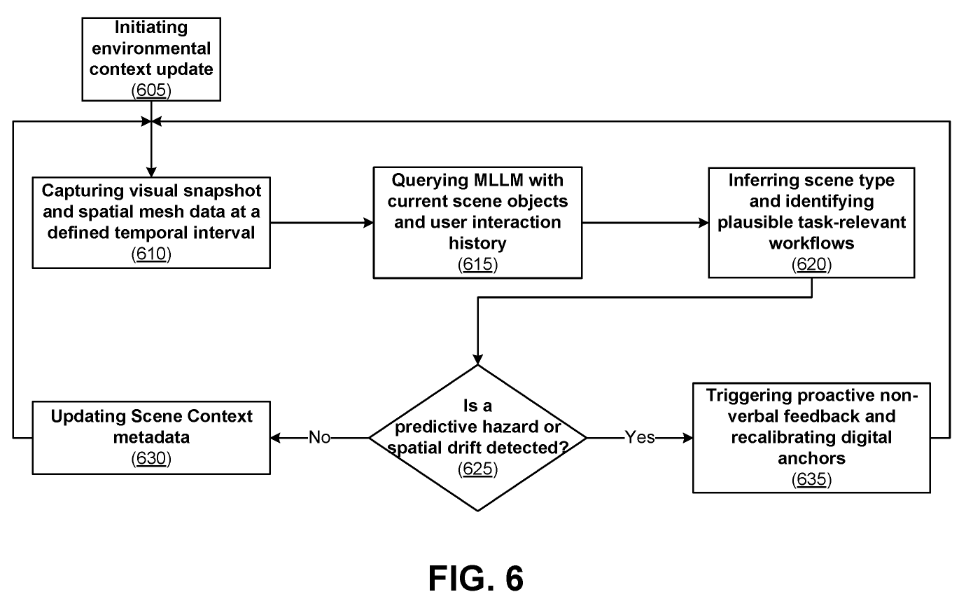

FIG. 6 illustrates a block diagram of a continuous feedback loop to maintain environmental awareness and ensure the spatial accuracy of digital overlays in the semantic reality system. The process begins with an automated trigger for a context update, which initiates the capture of high-resolution visual and spatial data at a predefined temporal frequency. This real-time environmental information can be processed by a multimodal intelligence layer that analyzes the current arrangement of objects alongside the user’s interaction history to infer the active scene type and identify relevant workflows. A decision point in this architecture can evaluate the environment for potential spatial drift or predictive hazards, such as a liquid container being moved into a risky proximity to electronic equipment. If a discrepancy or hazard is detected, the system proactively triggers non-verbal feedback and recalibrates the digital anchors to resolve any misalignment. By systematically updating scene metadata and refining the 3D coordinate space, the system ensures that the augmented intelligence remains precisely registered to the physical world, facilitating a stable and contextually responsive user experience.

The semantic reality system can implement an iterative environmental context update process 605 to maintain spatial fidelity and situational awareness. This process can function as a continuous feedback loop that ensures the digital representation of the physical environment remains synchronized with real-world changes. By systematically refreshing the scene metadata, the environmental context update process 605 allows the system to support the multi-level interaction architecture, specifically by providing the foundational data for identifying functional relationships and localized sub-components. This continuous monitoring can be used for achieving perceptual transparency, as it allows intelligent middleware to foresee or predict user needs and provide proactive assistance based on the current state of the workspace.

In some implementations, the environmental context update process 605 can be triggered by the environmental context module 210 at a regular sample rate (e.g., every 10 seconds) to verify the position and status of active digital anchors. This iterative temporal sampling allows the system to identify a third object at a third scale of interaction (e.g., the environment-level) and detect potential predictive hazards or new functional dependencies. By capturing these updates at a consistent frequency, the system can execute the decision block 625 to identify discrepancies between the established scene graph and the physical environment, effectively compensating for any environmental shifts or user-initiated changes in the object arrangement.

The system can implement block 610 as a continuous environmental context update process configured to maintain the spatial and semantic integrity of the augmented reality environment. This block involves the capture of high-resolution visual snapshots and corresponding spatial mesh data from the sensor(s) 205 at a defined temporal interval (e.g., every 10 seconds). By periodically refreshing the raw data of the physical environment, the system ensures that the intelligent middleware has access to the current arrangement of objects, which can be used for identifying a third object at an environment-level scale of interaction. This temporal sampling can allow the system to detect changes in the scene, such as the introduction of a new device or the repositioning of an existing object, enabling the generation of a scene graph that accurately reflects real-time functional relationships.

In some implementations, in block 610, a head-mounted display (e.g., wearable device 110) can utilize an integrated LiDAR sensor and an RGB pass-through camera to perform a synchronized scan of a user’s workspace. As the user manipulates a first object, such as a network router 120, the system captures a new spatial mesh that reflects the router's updated 3D coordinates. Substantially simultaneously, the visual snapshot captures a second object, such as a smartphone 130, and a third object, such as a beverage container 135, in proximity to the router. This data collection serves as the foundational input for the ML module 220 to determine the 3D position for a digital anchor and to identify a predictive hazard relationship, such as a liquid spill risk, without receiving a natural language text query from the user. By maintaining this regular sample rate, the system can effectively compensate for spatial drift and ensure that any visual overlay remains precisely registered to the physical environment.

A model, for example, a multimodal large language model (MLLM), query block 615 can be configured to process the current scene objects and user interaction history to generate context-aware intelligence. This block functions as the reasoning engine within the intelligent middleware, utilizing a model (e.g., first model 320) to synthesize multimodal inputs into a structured understanding of the environment. By ingesting the unified list of scene objects and the recognized physical actions (e.g., pointing at a sub-component or grabbing an object), the MLLM query block 615 can expand these natural interactions into a sophisticated natural language instruction set. This architecture effectively reduces the prompting burden on the user by automatically triggering queries based on the physical context and interaction scale, such as a detail-level engagement with a localized subregion.

In some implementations, the MLLM query block 615 can utilize a high-capacity model configured to evaluate the functional relationships and relational meaning between identified entities. If the sensor(s) 205 detect a user performing a stable pointing gesture toward a specific Ethernet port on network router 120, the block 615 identifies the target scale of interaction as a detail-level interaction and generates a prompt that specifically requests technical specifications or configuration steps for that sub-component. Substantially simultaneously, if a second object and a third object are identified in the workspace, the query block 615 analyzes the scene graph to detect inter-object dependencies, such as a sequential relationship for a hardware setup. This process ensures that the information retrieved by the second model 325 can be calibrated to the user's focus and the broader environmental context, facilitating the rendering of spatially registered visual overlays and relationship lines.

A logical inference process at block 620 can be configured to determine the environmental context and identify task-relevant assistance for the user. After querying the MLLM with the current scene objects and interaction history, the system can process this data to infer a specific scene type (e.g., a home office, a laboratory, or a consumer electronics workspace) and generate a list of plausible task-relevant workflows. This inference can be achieved by analyzing the semantic labels and spatial distribution of the identified objects within the scene graph. For example, the presence of a network router 120, a laptop 125, and various cables may trigger the system to infer a network configuration scene, subsequently surfacing workflows related to hardware installation or troubleshooting.

In some implementations, block 620, as the intelligent middleware, can utilize a model (e.g., first model 320) to evaluate the functional relationships and relational meaning between a plurality of physical objects to prioritize likely user needs. If the scene graph identifies a first object at a first scale of interaction, such as a localized Ethernet port on router 120, and a second object at an object-level, such as a smartphone 130, block 620 can infer a sequential relationship representing a task-based order of operations for device pairing. The system then identifies a workflow for Gateway Setup, which can function as the basis for generating a structured prompt. By inferring the user's intent through these plausible workflows rather than requiring an explicit natural language text query, the system can reduce the prompting burden and ensure that the retrieved information is calibrated to the specific environment-level dependencies of the physical workspace.

A decision block 625 can be configured to determine whether a predictive hazard or spatial drift has been detected within the augmented reality environment. This determination can be made using, for example, the ML module 220 and the environmental context module 210 by comparing the real-time visual snapshots and spatial mesh data captured in block 610 against the established scene graph and the current positions of the digital anchors. By evaluating the temporal and spatial stability of the environment, the system can identify a misalignment between a physical object and its corresponding digital representation (e.g., referred to as spatial drift) or recognize a change in the physical arrangement that creates a functional risk. Decision block 625 can function as a gateway for maintaining perceptual transparency, ensuring that the visual overlays remain precisely registered to the physical world even as the user moves or objects are manipulated.

In some implementations, in block 625, the system can identify a predictive hazard relationship by simulating a physical consequence of a change in position of the first object relative to a second object. For example, the ML module 220 can detect that an object (e.g., beverage container 135) has been moved within a specific proximity threshold of another object (e.g., peripheral hard drive 145). Rather than identifying a static risk, the system simulates the consequence of a potential spill (e.g., calculating liquid trajectory or impact on electronic circuitry) to determine the severity of the hazard. If the simulated physical consequence satisfies a criterion (e.g., exceeds a safety threshold), the system triggers a "Yes" path from the decision block. By utilizing these simulated outcomes as the basis for the generated prompt, the system can ensure that the preventative instructions are not merely based on proximity, but on a theory of mind regarding the physical outcomes of environmental changes. Similarly, the system can detect and resolve spatial drift by simulating the expected position of a digital anchor based on camera pose history and comparing it to the current spatial mesh.

A scene context update process block 630 can be configured to modify and refine the structured environment metadata based on the results of the multimodal reasoning and the identified task-relevant workflows. Block 630 can function as the primary data persistence layer for the environment-level interaction, ensuring that the unified list of scene objects and their associated attributes are updated to reflect the current semantic understanding of the physical environment. By updating the scene context metadata at regular intervals, the system maintains a high-fidelity digital twin that accounts for the current state, position, and relational meaning of identified entities, thereby providing a stable foundation for learning and proactive assistance.

In some implementations, the update at block 630 can include the intelligent middleware expanding the metadata for a specific digital anchor to include newly inferred functional dependencies, such as a sequential relationship between a network router 120 and a smartphone 130. If the environmental context module 210 identifies that a user is performing a hardware configuration task, block 630 updates the metadata to include a task-specific identifier and a set of state information for the objects involved. Further, this update may include the results of detail-level interaction, such as appending OCR-derived nutritional data or technical specifications to a localized sub-anchor. By synthesizing these multi-scale data points into the scene context metadata, the system ensures that the information remains available for subsequent retrieval by the multi-agent AI system, effectively reducing the prompting burden on the user by maintaining a continuously refined model of the physical workspace.

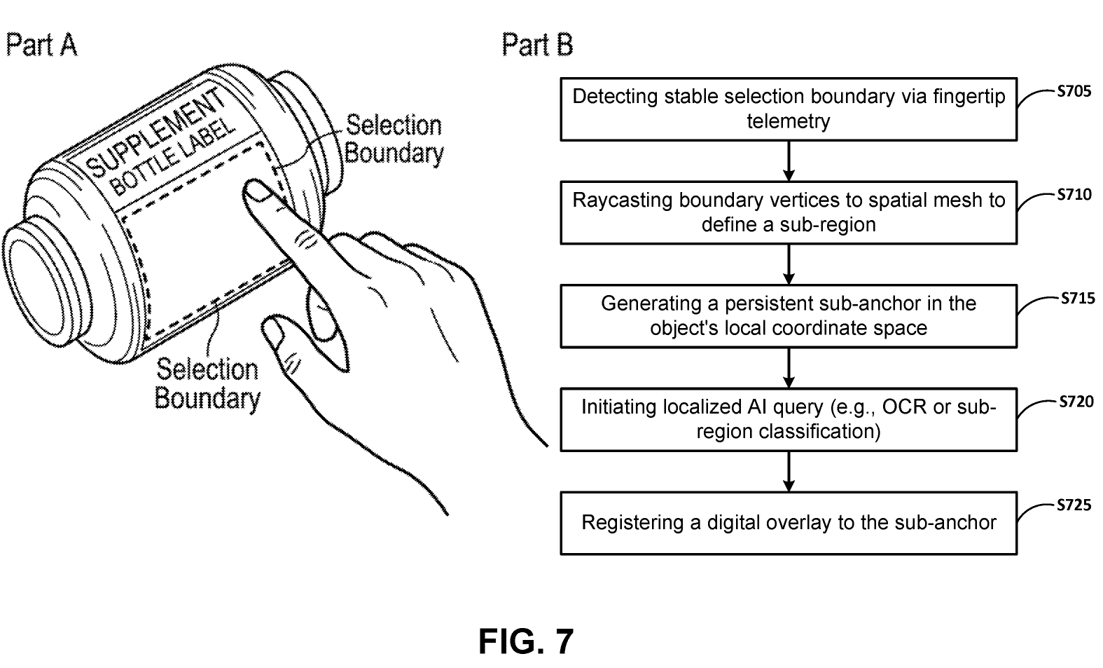

FIG. 7 illustrates a block diagram of a specialized interaction pipeline for the selection and processing of localized sub-regions on a physical object. This dual-part figure illustrates the transition from a manual user action to a digitally anchored, AI-driven assistance layer at the detail-level of the interaction hierarchy. Part A provides a first-person perspective of a user interacting with a physical entity, such as a supplement bottle label, by tracing a specific area of interest. This interaction is represented as a selection boundary that identifies a granular subset of the object's surface for further analysis. Part B details the underlying technical logic for transforming this transient physical gesture into a stable digital entity. This process involves capturing the spatial telemetry of the interaction, mapping those coordinates to the environmental mesh to define a three-dimensional sub-region, and generating a persistent digital marker within the object's local coordinate space. By establishing this localized anchor, the system can initiate targeted queries (e.g., optical character recognition or sub-component classification) and register a precise digital overlay that remains pinned to the identified sub-region even if the physical object is moved or rotated.

For example, at step S705, the system is configured to detect a stable selection boundary via fingertip telemetry. In some implementations, the sensor(s) 205 can monitor the user’s hand positions and fingertip proximity to a first object, such as a supplement bottle or a consumer electronics device. By analyzing high-frequency data from outward-facing infrared sensors and RGB cameras, the interaction module 225 identifies a deliberate tracing or framing gesture performed by the user 105. The system evaluates the temporal and spatial stability of the fingertip's path to distinguish a formal selection intent from incidental movement. For example, if a user’s finger dwells within a high-precision threshold of a localized sub-region for a specific duration, the system captures the 2D coordinates of the selection boundary relative to the current camera pose. This quantitative detection of intent allows the system to identify a first scale of interaction corresponding to a sub-component of the first object without requiring a natural language text query, effectively lowering the prompting burden for detailed inspection tasks.

Step S710 includes raycasting the vertices of the detected selection boundary to the spatial mesh to define a three-dimensional sub-region. For example, the anchor module 215 can utilize the 2D coordinates of the selection boundary captured in the previous step and projects rays from the current camera pose into the 3D environment. By calculating the intersection of these rays with the high-fidelity spatial mesh generated by the sensor(s) 205, the system can identify the volumetric area on the surface of the first object that corresponds to the user’s intent. This process transforms a transient 2D gesture into a grounded 3D geometry, allowing the system to isolate a specific sub-component, such as a localized port or a text block on a label, for high-precision digital engagement.

In some implementations, if a user traces a rectangular selection boundary around a nutrition facts table on a supplement bottle label, the system identifies the four corner vertices of that rectangle in the image plane. The anchor module 215 then performs 2D-to-3D re-projection by casting rays from the 6DoF camera pose through each vertex until they hit the spatial mesh representing the bottle’s surface. This can define a bounded sub-region within the object's coordinate space that is distinct from the object-level digital representation. By defining this localized sub-region at a first scale of interaction, the system provides the spatial context for the detail-level module 230 to initiate targeted tasks, such as performing optical character recognition (OCR) specifically on the ingredients or nutritional data contained within those boundaries.

Raycasting can be a computer vision and graphics technique used to determine the intersection of a conceptual ray with the geometric surfaces of a 3D scene. By calculating the trajectory of a ray from an origin point (e.g., a camera’s focal center) through a 2D coordinate on an image plane, the system can identify the point where that ray strikes the physical topology of the room. This process allows the semantic reality system to transform a user's 2D interaction, such as a fingertip position on a screen or a gaze vector, into a grounded 3D coordinate. For example, the anchor module 215 can utilize raycasting to bridge the gap between raw visual snapshots and the spatial mesh, ensuring that digital anchors and sub-anchors remain registered to physical objects even as the user’s perspective changes.

Step S715 includes generating a persistent sub-anchor in the local coordinate space of the first object. For example, the defined 3D sub-region can be used to establish a high-precision digital marker that is spatially registered to the specific sub-component of the object. Unlike a standard digital anchor that represents an entire physical entity, the sub-anchor can function as a localized coordinate system nested within the parent object's transform. By anchoring digital content to this specific sub-region, the system ensures that any visual overlay remains accurately pinned to the sub-component, such as a localized port or a specific block of text, even if the user physically manipulates, rotates, or moves the first object within the environment.

In some implementations, the anchor module 215 can create a sub-anchor for a localized Ethernet port on network router 120. As the user moves router 120 to inspect the back panel, the system tracks the parent digital anchor and simultaneously updates the 3D position of the nested sub-anchor to compensate for the change in orientation. This hierarchical anchoring architecture supports the first scale of interaction by allowing the detail level module 230 to maintain a stable reference point for information retrieved by the second model. This persistence can enable achieving perceptual transparency in complex tasks, such as maintaining a highlighted instruction over a specific mechanical part or keeping a translated text overlay registered to a fine-print label on a moving container.

Step S720 includes initiating a localized AI query to retrieve task-relevant information based on the established sub-anchor. In some implementations, this can represent the execution of the intelligent middleware at the first scale of interaction, where the system targets the specific 3D sub-region defined by the user’s selection boundary. By isolating this granular context, the ML module 220 can perform specialized analysis (e.g., optical character recognition (OCR) or sub-component classification) without the computational noise of the surrounding environment. This targeted querying reduces the prompting burden on the user by automatically identifying the nature of the sub-component and retrieving the appropriate technical or informational data from a second model.

In some implementations, in response to generating a sub-anchor for a localized Ethernet port on network router 120, the system initiates a query to, for example, a MLLM to identify the port’s specific function and status. For example, the first model may generate a structured prompt such as: "Identify the technical specifications and connection status for the highlighted WAN port at these 3D coordinates." Similarly, if the sub-anchor is registered to a nutrition facts table on a supplement bottle label, step S720 triggers an OCR pipeline to extract and summarize ingredient data or allergen warnings. By focusing the model’s attention on the sub-region, the system ensures high-precision retrieval of information that is calibrated to the detail-level of the semantic hierarchy, providing the user with situated digital assistance for complex manual tasks.

Step S725 includes registering a digital overlay to the sub-anchor established in the previous stage. In some implementations, the visual overlay module 245 can utilize the high-precision 3D coordinates of the persistent sub-marker to render task-relevant information directly onto the identified sub-component of the physical object. Because the sub-anchor is locked within the local coordinate space of the first object’s digital anchor, the system ensures that the visual overlay remains registered to the sub-component even as the first object moves or rotates within the physical environment. This spatial persistence provides the user with nonverbal feedback and situated intelligence (e.g., technical specifications, translated text, or step-by-step instructions) that is precisely aligned with the physical interface, thereby achieving perceptual transparency and reducing the cognitive load associated with interpreting complex or unfamiliar items.

In some implementations, if the localized AI query from step S720 identifies a sub-component of a network router 120 as a "WAN Port," the system renders a dashed rectangular highlight and a digital label indicating the port’s function and current connectivity status. If the user 105 picks up the router to examine its underside, the visual overlay module 245 dynamically updates the position of the "WAN Port" label in real time, compensating for the physical change in position to ensure the information remains pinned to the specific Ethernet port. Similarly, for a detail-level interaction directed at a supplement bottle label, the system may display a summarized information card containing OCR-derived nutritional data, such as a breakdown of "L-CARNITINE" content, overlaid directly on the physical text block. By displaying the visual overlay based on the information retrieved at this granular scale, the system effectively bridges the gap between the physical world and digital knowledge without requiring a natural language text query from the user.

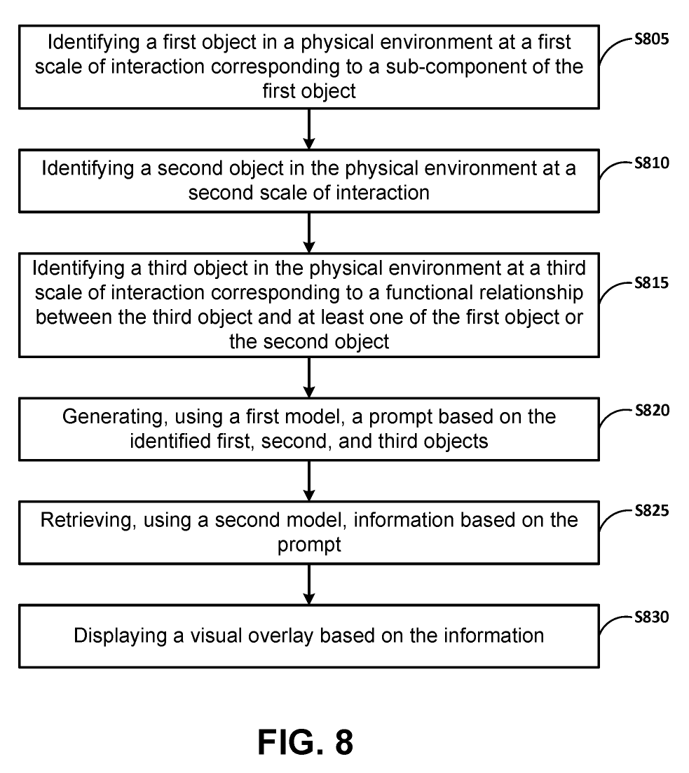

Example 1. FIG. 8 illustrates a block diagram of a method for operating the semantic reality system according to an example implementation. As shown in FIG. 8, in step S805 identifying a first object in a physical environment at a first scale of interaction corresponding to a sub-component of the first object. In step S810 identifying a second object in the physical environment at a second scale of interaction. Alternatively, identifying a second object in the physical environment at a second scale of interaction corresponding to a functional relationship between the second object and at least one of the first object or a third object (skip S815). In step S815 identifying a third object in the physical environment at a third scale of interaction corresponding to a functional relationship between the third object and at least one of the first object or the second object. In step S820 generating, using a first model, a prompt based on the first object, the second object, and the third object. In step S825 retrieving, using a second model, information based on the prompt. In some implementations, the first model and the second model can be a multi-modal model that includes the first model and the second model. In step S830 displaying a visual overlay based on the information.

Example 2. The method of Example 1 can further include generating a scene graph representing the functional relationship between the third object and the first object or the second object, establishing a digital anchor for the first object in a 3D coordinate space, and displaying a visual overlay in the physical environment based on the information retrieved.

Example 3. The method of Example 2 can further include detecting a physical change in a position of the first object and updating the scene graph and the prompt in response to the physical change to reflect a new functional relationship between the first object and the second object.

Example 4. The method of Example 2 can further include displaying a relationship line in the physical environment connecting the first object and the third object, wherein the relationship line can be a non-verbal representation of the scene graph.

Example 5. The method of Example 2, wherein determining a 3D position for the digital anchor and generating the scene graph can further include capturing a frame from a pass-through camera and determining a 2D bounding box for the first object within the frame, storing a camera pose associated with the frame, and casting a ray from the camera pose through the 2D bounding box to intersect with a spatial mesh of the physical environment.

Example 6. The method of Example 2, wherein an anchor for the sub-component of the first object can be a persistent digital marker that maintains a fixed position within a local coordinate space of the digital anchor, such that the visual overlay can remain registered to the sub-component of the first object as the first object moves within the physical environment.

Example 7. The method of Example 6 can further include compensating for a spatial drift of the digital anchor and the anchor for the sub-component of the first object by capturing visual snapshots of the physical environment at a regular sample rate, comparing the visual snapshots to the scene graph to detect a misalignment between the first object and the digital anchor, and calibrating the 3D coordinate space to resolve the misalignment and maintain registration of the visual overlay.

Example 8. The method of Example 1, wherein the first model and the second model can operate as a multi-agent system, and the first model can be configured to generate the prompt by expanding a user-initiated physical interaction into a natural language instruction set for the second model.

Example 9. The method of Example 1, wherein identifying the functional relationship includes categorizing the functional relationship into at least one of a grouping relationship representing a set of related objects, a parallel relationship representing interchangeable objects, or a sequential relationship representing a task-based order of operations, wherein identifying the sequential relationship includes querying a scene graph for a directed edge between a digital anchor of the first object and a digital anchor of the second object; and identifying a task-based order of operations based on a detected state of the physical environment.

Example 10. The method of Example 1, wherein the first object can be a container and the sub-component is a label and the method can further include performing optical character recognition (OCR) on the sub-component of the first object to identify ingredients or nutritional data.

Example 11. The method of Example 1, wherein identifying the functional relationship can include identifying a predictive hazard relationship and the information retrieved can include a preventative instruction to avoid a physical interaction.

Example 12. The method of Example 1, wherein the prompt can be generated in response to a detected physical interaction with the first object and without receiving a natural language text query from a user.

Example 13. The method of Example 1, wherein the first scale of interaction, the second scale of interaction, and the third scale of interaction can represent tiers of a semantic hierarchy, where the first scale of interaction includes a detail-level focused on a localized subregion of a physical object, the second scale of interaction includes an object-level focused on a digital representation of a whole physical object, and the third scale of interaction includes an environment-level focused on a semantic mapping of functional dependencies between a plurality of physical objects.

Example 14. The method of Example 1, wherein identifying the first object, the second object, or the third object can include detecting a user intent cue including at least one of a fingertip proximity threshold, a gesture stability duration, or a gaze fixation metric and filtering the user intent cue through a semantic hierarchy to select the first scale of interaction, the second scale of interaction, or the third scale of interaction.

Example 15. The method of Example 1 can further include resolving a linguistic ambiguity in an auditory input by identifying an active selection state of a digital anchor associated with the first object or the second object and cross-referencing a pronoun in the auditory input with the active selection state to disambiguate a target of the prompt.

Example 16. The method of Example 1 can further include simulating a physical consequence of a change in position of the first object relative to the second object wherein the prompt generated by the first model can be further based on the simulated physical consequence.

Example 17. The method of Example 1, wherein identifying the first object at the first scale of interaction can include capturing, via a spatial sensor, a point cloud representing a surface of the first object, mapping (or associating) a user intent cue to a 3D coordinate on the surface, and defining a sub-anchor within a local coordinate space of the first object at the 3D coordinate.

Example 18. The method of Example 1, wherein generating the prompt using the first model can include inputting, into the first model, a multimodal vector including a semantic label of the first object, a 3D transform of the sub-component, and a temporal duration of a detected user gesture and expanding, via the first model, the multimodal vector into a natural language instruction set that identifies a task-specific context for the second model.

Example 19. The method of Example 1, wherein displaying the visual overlay can include performing a 2D-to-3D re-projection to align the retrieved information with a 3D digital anchor of the first object; and rendering the visual overlay as a spatially-locked graphic that persists at the first scale of interaction regardless of a change in a user's perspective.

Example 20. A method can include any combination of one or more of Example 1 to Example 19.

Example 21. A non-transitory computer-readable storage medium comprising instructions stored thereon that, when executed by at least one processor, are configured to cause a computing system to perform the method of any of Examples 1-20.

Example 22. An apparatus comprising means for performing the method of any of Examples 1-20.

Example 23. An apparatus comprising at least one processor and at least one memory including computer program code, the at least one memory and the computer program code configured to, with the at least one processor, cause the apparatus at least to perform the method of any of Examples 1-20.

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus at least to perform any of the methods described above.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Further to the descriptions above, a user may be provided with controls allowing the user to make an election as to both if and when systems, programs, or features described herein may enable collection of user information (e.g., information about a user’s social network, social actions, or activities, profession, a user’s preferences, or a user’s current location), and if the user is sent content or communications from a server. In addition, certain data may be treated in one or more ways before it is stored or used, so that personally identifiable information is removed. For example, a user’s identity may be treated so that no personally identifiable information can be determined for the user, or a user’s geographic location may be generalized where location information is obtained (such as to a city, ZIP code, or state level), so that a particular location of a user cannot be determined. Thus, the user may have control over what information is collected about the user, how that information is used, and what information is provided to the user.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example implementations may include various modifications and alternative forms, implementations thereof are shown by way of example in the drawings and will herein be described in detail. It should be understood, however, that there is no intent to limit example implementations to the particular forms disclosed, but on the contrary, example implementations are to cover all modifications, equivalents, and alternatives falling within the scope of the claims. Like numbers refer to like elements throughout the description of the figures.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example implementations. Example implementations, however, be embodied in many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular implementations only and is not intended to be limiting of example implementations. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system’s registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

What is claimed is:

1. A method, comprising:
identifying a first object in a physical environment at a first scale of interaction corresponding to a component of the first object;
identifying a second object in the physical environment at a second scale of interaction corresponding to a functional relationship between the second object and at least one of the first object or a third object;
generating, using a model, a prompt based on the first object, the second object, and the third object;
retrieving, using the model, information based on the prompt; and
displaying a visual overlay based on the information.

2. The method of claim 1, further comprising:
generating a scene graph representing the functional relationship between the third object and the first object or the second object;
establishing a digital anchor for the first object in a 3D coordinate space; and
displaying a visual overlay in the physical environment based on the information retrieved.

3. The method of claim 2, further comprising:
detecting a physical change in a position of the first object; and
updating the scene graph and the prompt in response to the physical change to reflect a new functional relationship between the first object and the second object.

4. The method of claim 2, further comprising:
displaying a relationship line in the physical environment connecting the first object and the third object, wherein
the relationship line is a non-verbal representation of the scene graph.

5. The method of claim 2, wherein determining a 3D position for the digital anchor and generating the scene graph further comprises:
capturing a frame from a pass-through camera and determining a 2D bounding box for the first object within the frame;
storing a camera pose associated with the frame; and
casting a ray from the camera pose through the 2D bounding box to intersect with a spatial mesh of the physical environment.

6. The method of claim 2, wherein
an anchor for the component of the first object is a persistent digital marker that maintains a fixed position within a local coordinate space of the digital anchor, such that the visual overlay remains registered to the component of the first object as the first object moves within the physical environment.

7. The method of claim 6, further comprising compensating for a spatial drift of the digital anchor and the anchor for the component of the first object by:
capturing visual snapshots of the physical environment at a regular sample rate;
comparing the visual snapshots to the scene graph to detect a misalignment between the first object and the digital anchor; and
calibrating the 3D coordinate space to resolve the misalignment and maintain registration of the visual overlay.

8. The method of claim 1, wherein
the model is a multi-modal model that includes a first model and a second model,
the first model and the second model operate as a multi-agent system, and
the first model is configured to generate the prompt by expanding a user-initiated physical interaction into a natural language instruction set for the second model.

9. The method of claim 1, wherein identifying the functional relationship includes categorizing the functional relationship into at least one of:
a grouping relationship representing a set of related objects;
a parallel relationship representing interchangeable objects; or
a sequential relationship representing a task-based order of operations, wherein identifying the sequential relationship includes querying a scene graph for a directed edge between a digital anchor of the first object and a digital anchor of the second object; and identifying a task-based order of operations based on a detected state of the physical environment.

10. The method of claim 1, wherein
the first object is a container and the component is a label, the method further comprising:
performing optical character recognition (OCR) on the component of the first object to identify ingredients or nutritional data.

11. The method of claim 1, wherein
identifying the functional relationship includes identifying a predictive hazard relationship, and
the information retrieved includes a preventative instruction to avoid a physical interaction.

12. The method of claim 1, wherein the prompt is generated in response to a detected physical interaction with the first object and without receiving a natural language text query from a user.

13. The method of claim 1, wherein the first scale of interaction, the second scale of interaction, and a third scale of interaction represent tiers of a semantic hierarchy, wherein:
the first scale of interaction includes a detail-level focused on a localized subregion of a physical object;
the second scale of interaction includes an object-level focused on a digital representation of a whole physical object; and
the third scale of interaction is associated with the third object and includes an environment-level focused on a semantic mapping of functional dependencies between a plurality of physical objects.

14. The method of claim 1, wherein identifying the first object, the second object, or the third object comprises:
detecting a user intent cue including at least one of a fingertip proximity threshold, a gesture stability duration, or a gaze fixation metric; and
filtering the user intent cue through a semantic hierarchy to select the first scale of interaction, the second scale of interaction, or a third scale of interaction associated with the third object.

15. The method of claim 1, further comprising resolving a linguistic ambiguity in an auditory input by:
identifying an active selection state of a digital anchor associated with the first object or the second object; and
cross-referencing a pronoun in the auditory input with the active selection state to disambiguate a target of the prompt.

16. The method of claim 1, further comprising:
simulating a physical consequence of a change in position of the first object relative to the second object; and
wherein the prompt generated by the model is further based on the simulated physical consequence.

17. The method of claim 1, wherein identifying the first object at the first scale of interaction comprises:
capturing, via a spatial sensor, a point cloud representing a surface of the first object;
mapping a user intent cue to a 3D coordinate on the surface; and
defining a sub-anchor within a local coordinate space of the first object at the 3D coordinate.

18. The method of claim 1, wherein the model is a multi-modal model that includes a first model and a second model and generating the prompt using the first model comprises:
inputting, into the first model, a multimodal vector including a semantic label of the first object, a 3D transform of the component, and a temporal duration of a detected user gesture; and
expanding, via the first model, the multimodal vector into a natural language instruction set that identifies a task-specific context for the second model.

19. A non-transitory computer-readable storage medium comprising instructions stored thereon that, when executed by at least one processor, are configured to cause a computing system to:
identify a first object in a physical environment at a first scale of interaction corresponding to a sub-component of the first object;
identify a second object in the physical environment at a second scale of interaction;
identify a third object in the physical environment at a third scale of interaction corresponding to a functional relationship between the third object and at least one of the first object or the second object;
generate, using a first model, a prompt based on the first object, the second object, and the third object;
retrieve, using a second model, information based on the prompt; and
display a visual overlay based on the information.

20. An apparatus comprising at least one processor and at least one memory including computer program code, the at least one memory and the computer program code configured to, with the at least one processor, cause the apparatus to:
identify a first object in a physical environment at a first scale of interaction corresponding to a sub-component of the first object;
identify a second object in the physical environment at a second scale of interaction;
identify a third object in the physical environment at a third scale of interaction corresponding to a functional relationship between the third object and at least one of the first object or the second object;
generate, using a first model, a prompt based on the first object, the second object, and the third object;
retrieve, using a second model, information based on the prompt; and
display a visual overlay based on the information.
